(19) United States
(12) Patent Application Publication
(10) Pub. No.: US 2010/0271576 A1
(43) Pub. Date: Oct. 28, 2010

(54) OPTICAL COMPENSATION FILM FOR LIQUID CRYSTAL DISPLAYS AND INVENTIONS ASSOCIATED THEREWITH

(75) Inventors: Detlef Pauluth, Ober-Ramstadt (DE); Bernhard Rieger, Munster-Altheim (DE); Ulrich Siemann, Weil am Rhein (DE); Ilona Herm, Kandern (DE)

Correspondence Address: VOLPE AND KOENIG, P.C., UNITED PLAZA, 30 SOUTH 17TH STREET, PHILADELPHIA, PA, 19103, US

(73) Assignees: LOFO HIGH TECH FILM GMBH, Weil am Rhein (DE); MERCK PATENT GMBH, Darmstadt (DE)

(21) Appl. No.: 12/810,330

(22) PCT Filed: Dec. 4, 2008
(86) PCT No.: PCT/EP08/10264

§ 371 Date: Jun. 24, 2010

(30) Foreign Application Priority Data
Dec. 24, 2007 (EP) 07025159.0

(51) Int. Cl. G02F 1/1335; C09K 19/02; B29D 11/00; B05D 5/06; B32B 37/00; C09K 19/12

(52) U.S. Cl. 349/96; 349/117; 428/1.33; 264/2.7; 427/163.1; 156/308.2; 252/299.66

(57) ABSTRACT

Compensation films for liquid crystal displays, polarizer plates having at least one such compensation film, liquid crystal displays having compensation films, and a method for producing compensation films, polarizer plates, and liquid crystal displays, as well as the use of compounds of the formula (I) described below in more detail as additives to compensation films for liquid crystal displays is provided. The optical compensation films include one or more rod-shaped liquid crystals of the formula (I) as additives, wherein the radicals have the meanings provided in the description for adjusting suitable retardation values Re and Rth.

The invention relates to compensation films for liquid crystal displays with additives of rod-shaped liquid crystals of formula I named below, polarizer plates that have at least one such compensation film, liquid crystal displays that have compensation films of the mentioned type, as well as methods for producing the mentioned compensation films, polarizer plates, and liquid crystal displays, the use of the compounds of formula I described below in more detail as additives to compensation films for liquid crystal displays, as well as additional invention subject matters that will become clear below.

Liquid crystals are materials that have both crystal-like and also liquid-like properties.

Materials that have liquid-crystal properties can be ordered in principle in one of two different classes of mesomorphic materials: anisometric and amphiphilic molecules. In the first class, anisometric, rod-shaped (calamitic), or disk-shaped (discotic) molecules can be combined that have, above all, thermotropic, liquid-crystal phases. Polycatenar (calamitic with several flexible chains on one or two ends) or bent (banana-shaped) molecules are also known. The second class stands for amphiphilic molecules, such as detergents and lipids that can often form, in addition to lyotropic, also thermotropic mesophases.

The liquid-crystal phases are divided according to the degree of long-range order of their components and the symmetry of the mesophases. Mesophases without orientation order that nevertheless exhibit positional long-range order are designated as plastic crystals. If the orientation order is indeed maintained, but the positional long-range order is completely lost, the mesophases are called nematic liquid-crystalline phases. If the long-range order is lost in only one or two spatial directions, then it involves positionally long-range ordered mesophases to which smectic and columnar phases belong.

Thermotropic liquid crystals are used, for example, in electro-optical displays, such as liquid crystal displays (or monitors).

Liquid crystal displays (LCD) are increasingly being used frequently instead of cathode ray tubes, because they have small thickness, low weight, and low power consumption.

As a rule, liquid crystal displays include at least two polarizers above or below the area encompassing the liquid crystals, (transparent) electrodes, spacers, and (e.g., glass) plates for regulating the alignment and the supply of the liquid crystal compounds themselves, in addition they can also optionally encompass one or more compensation films, brightness-amplifying films, prism films, diffuser films, optical fiber plates, reflective layers, and light sources, as well as thin-film transistors (TFT) as a component of the actual liquid crystal cell. Plasma displays also require suitable protective films, on one side, as protection, on the other side, as a basis for functional coatings, such as anti-reflex coatings.

There is a series of different possible constructions for liquid crystal displays of which a few will be described below as examples.

As mentioned, as a rule, liquid crystal displays have a pair of polarizing plates (polarizer plates) and liquid crystal cells lying in-between. These typically include two plan-parallel substrates of which at least one is transparent and at least one has, on the inside, an electrode layer and a layer of typically rod-shaped liquid crystal molecules located in-between. The rod-shaped liquid crystal molecules are laid between the substrates and the electrode layer is used to apply a voltage to the rod-shaped liquid crystal molecules. Typically an orientation layer for uniform alignment of the rod-shaped liquid crystal molecules is provided on the substrates or on the electrode layer. Each polarizer plate includes, e.g., a pair of transparent protective films and at least one polarizing membrane lying in-between (polarizer membrane).

In a liquid crystal display, an optical compensation film (phase delayer, delay plate) is often placed between the liquid crystal cell and the polarizer plate, in order to prevent undesired coloring in the displayed image occurring due to, among other things, the inherent double refraction of the liquid crystal film. The layered composition of the polarizer plate is used as an elliptically polarizing plate. As a rule, the optical compensation film also increases the viewing angle (angle relative to the surface of the display device) at which the image can still be viewed with acceptable contrast. As the optical compensation film, among others, a stretched double-refractive polymer film or a film coated with double-refractive substances is used.

For the case of thin-film liquid crystal displays (TFT) of the twisted nematic cell type (TN), the optical compensation film is provided between the liquid crystal cell and the polarizer plate, in order to guarantee high image quality, but this type is often rather thick.

Other arrangements provide that, for example, the optical compensation film is provided on a surface of the polarizer plate and simultaneously has the function of a protective film, while an elliptically polarizing polarizer plate is arranged on the opposite side, with this polarizer plate also being able to be provided with a protective film on the outside. This produces relatively thin monitors and, for the case of viewing from the front, high-contrast images, but it can result in deformation of the optical compensation film and thus to undesired phase retardation and thus color deviation in the image. In order to overcome this problem, for the case of another type of display, an optically anisotropic layer that includes a discotic compound is provided on a transparent carrier, in order to form an optical compensation film that is used as a protective film for the polarizer plate, which leads to a thin and relatively durable liquid crystal display.

Arrangements in which one of the protective films of the polarizer plate represents the optical compensation film directly are also known that can produce especially thin films.

Many other arrangements have been found that each have specific advantages.

They all have in common that they have at least one optical compensation film for increasing the viewing angle.

This can consist of, for example, a cellulose acylate, in particular, a cellulose-C₁-C₇-alkanoate (Z—C₁-C₇-A), e.g., cellulose acetate and/or cellulose propionate (e.g., CAP) or advantageously cellulose acetate (triacetyl cellulose, TAC) as a base. Normally, a cellulose acylate film is optically isotropic with respect to the vertical axis relative to the film surface (with relatively low retardation). In order to be able to act as an optical compensation film, however, it must exhibit optical anisotropy and advantageously high retardation (═Optical delay). In addition to stretched double-refractive synthetic polymer materials, anisotropic films that include discotic molecules have also been proposed that are produced through alignment of the discotic molecules and subsequent fixing in the aligned shape. U.S. Pat. No. 6,559,912 and US 2003/0218709 describe cellulose acetate films with discotic molecules, e.g., on 1,3,5-triazine base or polymer liquid crystals or ketone, ether, and/or ester compounds or those with moieties that can be polymerized.

Difficulties in the use of such additives can occur, for one, in the compatibility with the solvents and other additives used in the production of Z—C₁-C₇-A (in particular, TAC) films. Second, due to the low compatibility of the additives being used with the end products or due to volatility and/or diffusion tendency that is too high, it can lead to lack of strength (durability) of the resulting films.

There is also, as already indicated above, an abundance of different LCD systems, so that it can be difficult to adapt films to the desired conditions. Thus it is conceivable that only one film is used for compensation, or two or more, and that according to the thickness and other requirements, the properties such as thickness and mass, etc., of the compensation film(s) must be adaptable to certain requirements of an LCD.

The delay values in the direction of the plane (Ro; so-called “in plane” retardation; also often called Re) and in the direction of the thickness (Rth; so-called “out of plane” retardation) of the optical compensation film are each described by the following formulas:

Ro(=Re)=(nx−ny)×d (I)

Rth={[(nx+ny/2]−nz}×d (II)

Here, nx is the index of refraction along the slow axis (the axis with the greatest index of refraction, i.e., the direction of oscillation where a wave has the slower propagation rate, “slow axis”) in the plane of the film, ny is the index of refraction along the fast axis (the axis with the lowest index of refraction, i.e., the direction of oscillation, where a wave has the faster index of refraction, “fast axis”) in the plane of the film (perpendicular to nx), and nz is the index of refraction in the direction of the surface of the film (perpendicular to nx and ny), d is the thickness of the film (in mm).

Setting the suitable values for Ro and Rth depends on the type of liquid crystal cell being used and the change in the polarization state caused in this way for driving the cell.

Different retardation values are needed for correction for the typical types of displays for image presentation, e.g., TN (twisted nematic), STN (super twisted nematic), VA (vertically aligned), IPS (in plane switching).

In light of the difficulties named above, the problem arises of finding compensation films that, one, allow a precise setting of the retardation values Ro (=Re) and Rth and that have a high stability of these values at which the additives being used have good compatibility both during production and also in the end product, cause no coloring or cloudiness, and with which the required optical properties can be set through suitable measures, such as stretching flexibly to desired displays, for example, with respect to the thickness that can be used and the question whether, instead of two compensation films, only one could be used. If the substances being used are compatible across a large concentration range, the retardation values can be varied both across the concentration of the additives being used and also through specially adapted post-processing, which would give great flexibility for the application.

It was now found that it is possible through the use of certain rod-shaped additives to achieve one to all of the goals specified when the problems were stated.

Therefore, in a first embodiment, the invention relates to an optical compensation film (advantageously for liquid crystal displays) on a cellulose acylate base, in particular, on a CAP or advantageously cellulose acetate base that has at least one aromatic compound with at least two aromatic rings, characterized in that the aromatic compound involves one of Formula I,

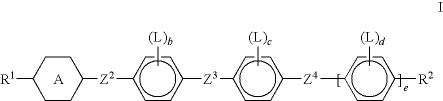

where
R¹ is a straight-chain alkyl or alkoxy with 1 to 12 C atoms, wherein one or more CH₂ groups can be replaced by —O—, —S—, —CO—, —CO—O—, —O—CO—, —O—CO—O—, —NR⁴—, —CO—NR⁴—, —NR⁴—CO— so that O atoms and/or S atoms are not linked to each other directly, and wherein one or more H atoms can also be replaced by F.

R² is CN, F, Cl, or straight-chain alkyl or alkoxy with 1 to 12 C atoms, wherein one or more CH₂ groups can also be replaced by —O—, —S—, —CO—, —CO—O—, —O—CO—, —O—CO—O— (alternatively or additionally), —NR⁴— (alternatively or additionally), —CO—NR⁴—, —NR⁴—CO— so that O atoms and S atoms are not linked to each other directly, and wherein one or more H atoms can also be replaced by F,

the ring

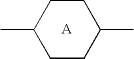

signifies either

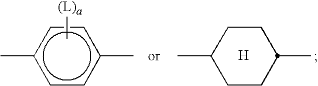

Z²-Z⁴ each signify —CO—O—, —O—CO—, —CONR⁴—, —NR⁴CO—, —CH₂O—, —OCH₂—, —CH₂S—, —SCH₂—, or a simple bond, advantageously a simple bond, independent of each other,
R⁴ signifies hydrogen or C₁-C₇-alkyl,
the moieties L signify H, F, or one of the moieties L also signifies Cl, independent of each other,
a, b, c, and d each signify a whole number 0, 1, or 2, independent of each other, and
e signifies a whole number 0 or 1.

The invention also relates to a method for the production of an optical compensation film (advantageously for liquid crystal displays) that includes at least one compound of Formula I that includes one or more compounds of Formula I, wherein a compound of Formula I is mixed with the starting materials for the compensation film during production. Advantageously, the film is stretched in a subsequent step in at least one direction, for example, in one to three directions (x, y, and z, for example, in the z direction by means of shrink films that are subsequently to be discarded), advantageously in two directions.

In another embodiment, the invention relates to a polarization plate (advantageously for liquid crystal displays) that has a pair of transparent protective films and a polarizing membrane between the protective films, wherein at least one of the transparent protective films has at least one optical compensation film on a cellulose acylate base that includes one or more compounds of Formula I, as well as a method for its production.

In another embodiment, the invention relates to a liquid crystal display that has at least one optical compensation film that includes at least one compound of Formula I, as well as a method for its production.

In another embodiment of the invention, this relates to the use of at least one compound of Formula I for the production of optical compensation films for liquid crystal displays, wherein at least one compound of Formula I is added to at least one compensation film for the production of the compensation film and in another step the compensation film is advantageously then used for the production of a liquid crystal display.

The general expressions and symbols used above and below advantageously have the meanings named above and below, as long as not specified differently and as long as they have not also already been defined above in the introduction, wherein, for each subject matter of the invention, independent from each other, one, several, or all of the general expressions or symbols could be replaced by specific definitions named below, which leads to preferred embodiments of the invention.

Optical compensation films are also designated below only as “compensation films.” According to the invention, optical compensation films on the cellulose acylate base, in particular, on a CAP or advantageously cellulose acetate base, are preferred.

Cellulose acylate designates, in particular, a cellulose triacylate, wherein the acyl moieties can be equal or different (in particular, statistically), advantageously a corresponding cellulose-tri-C₁-C₇ alkanoate, advantageously cellulose-tri-C₁-C₄ alkanoate, such as, butyrate, propionate, and/or acetate, such as, in particular, CAP (cellulose aceto propionate), or TAC (cellulose triacetate or triacetyl cellulose).

Advantageously, the degree of acyl substitution (DS), that is, the number of bound acyl moieties per cellulose sub-unit (monosaccharide sub-unit with 6 carbon atoms) lies at 2.4 to 3, in particular, between 2.7 and 2.98.

For example, in the case of triacetyl cellulose, the cellulose acetate advantageously has an acetic acid content from 59.0 to 61.5%, in particular, from 59.5 to 61.3%. The expression “acetic acid content” here designates the weight quantity of bound acetic acid per C₆ sub-unit of acetyl cellulose. The experimental designation can be defined, for example, according to ASTM: D-817-91 (“Tests of Cellulose Acetate”) or corresponding regulations. If not indicated differently, the values of the acetic acid content specified above and below relate to the ASTM:D-817-91 method.

The polymolecularity (the ratio of the weight average to number average), also designated as polydispersity), that is, the ratio of the average value of the molecular weight related to the quantity of material (M_{W}=weight average molecular weight) to the average value of the molecular weight related to number (Mₙ=number average molecular weight), for cellulose acetate films that are according to the invention or that can be produced according to the invention can lie, for example, in the range from 1.5 to 7, such as, e.g., between 2 and 4. The molecular weight is here defined by means of gel permeation chromatography with chloroform or methylene chloride as a solvent.

A compensation film according to the invention is advantageously a stretched film, in particular, stretched in two directions (biaxial), whose thickness, content of compound(s) of Formula I, and stretching parameters are selected so that it has the retardation values Ro (=Re) and Rth explained below as preferred.

Advantageously, a compensation film according to the invention has a content from 0.5 to 10 weight percent, in particular, from 2 to 8 weight percent, even more preferred from 2 to 6 weight percent, with respect to the total weight of the compensation film.

“Weight” (e.g., in weight percent or wt. %) is defined synonymously with mass in this disclosure.

The optical compensation film according to the invention on a cellulose acylate base includes at least one compound of Formula I, in particular, for setting a suitable retardation Ro and Rth as defined above. The method for the production of products according to the invention and the use likewise include advantageously, as a functional feature, the purpose of setting a suitable retardation Ro and Rth as defined above.

Preferred compounds of Formula I are selected from the following sub-formulas:

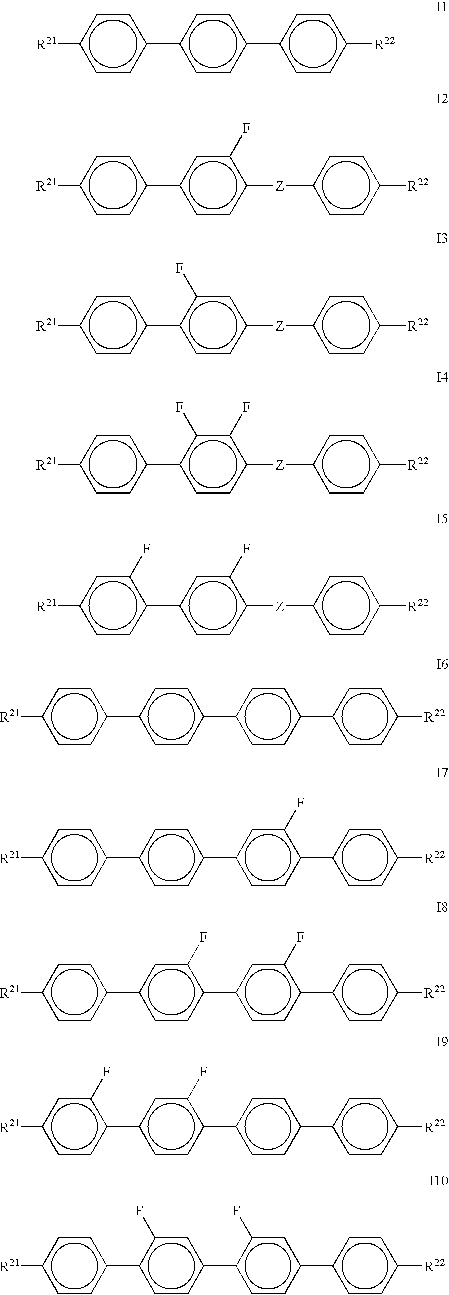

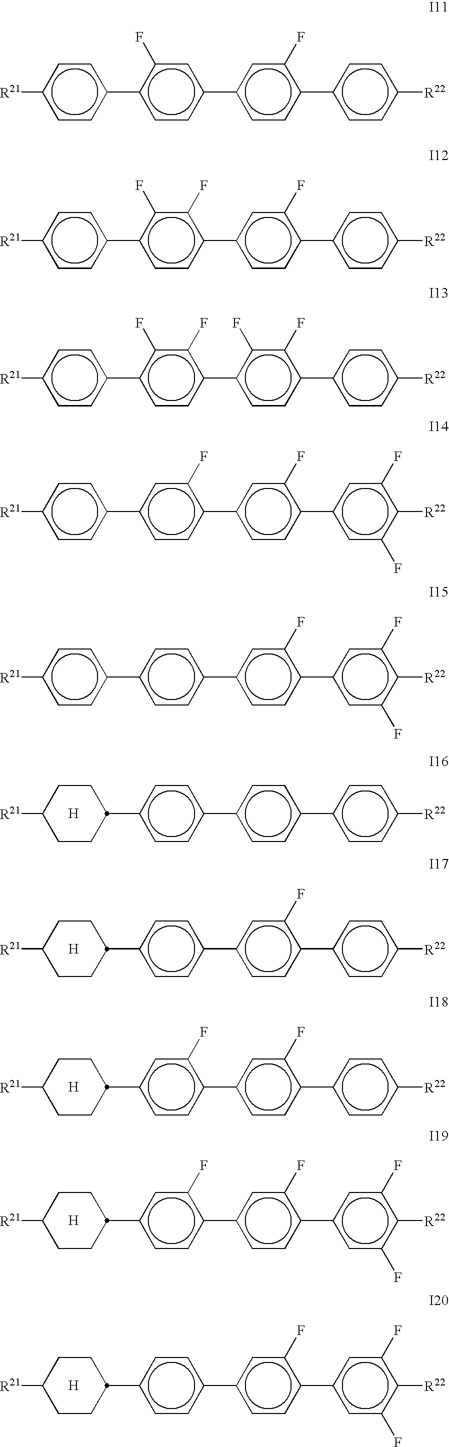

wherein R²¹ stands for R¹ and R²² for R², R₁ and R² have the meanings specified in Formula I, and Z has one of the meanings specified for Z³ in Formula I and advantageously signifies —COO— or a simple bond, very especially preferred a simple bond.

Especially preferred are the compounds of Formulas I2, I3, I4, I11, I15, and I17.

In the compounds of Formulas I and their sub-formulas, R¹ and R² each signify, independent of each other, advantageously straight-chain alkyl or alkoxy with 1 to 7 C atoms. R¹ signifies, especially preferred, CH₃, C₂H₅, n-C₃—H₇, n-C₄—H₉, n-C₅H₁₁, OCH₃, or OC₂H₅. R² signifies, especially preferred, F, Cl, NH₂ (alternatively or additionally), CH₃, C₂H₅, n-C₃H₇, n-C₄H₉, n-C₅H₁₁, OCH₃, or OC₂H₅.

Further preferred are compounds of Formula I and their sub-formulas, wherein R¹ stands for R′—Z¹ and/or R² for R″—Z⁵, wherein R′ and R″ each signify, independent of each other, alkyl or alkoxy with 1 to 12, advantageously with 1 to 7 C atoms, and Z¹ and Z⁵ each signify, independent of each other, —CO—, —CO—O—, —O—CO—, —CONR⁴—, or —NR⁴CO—. Z′ and Z⁵ advantageously signify —CO—O— or —O—CO—. Additional preferred compounds of Formula I and their sub-formulas are those, wherein R¹ stands for R′—CO—O— and/or R² for R″—CO—O—, as well as those, wherein R¹ stands for R′—O—CO— and/or R² for R″—O—CO—.

Z², Z³, and Z⁴ in Formula I advantageously signify —COO—, —OCO—, or a simple bond, especially preferred a simple bond.

“Include” or “comprise” or “have” mean that, in addition to the listed features and/or components, other features, processing steps, and/or components could still be present, i.e., a non-exhaustive listing is provided. In contrast, “contain” means that, for an embodiment designated this way, only the mentioned features, processing steps, and/or components are given.

The compounds of Formula I and their sub-formulas can be illustrated according to known methods, as they are described in the literature (e.g., in standard works, such as Houben-Weyl, Methoden der Organischen Chemie [Methods of Organic Chemistry], Georg-Thieme-Verlag, Stuttgart), and indeed, under reaction conditions that are known and suitable for the mentioned reactions. Here, one could also use known variants not explained in detail here.

Additional suitable methods for the production of compounds of Formulas I1 to I20 are described in the literature. Compounds of Formula I1 to I5 and their production are described, for example, in EP 0 132 377 A2. Compounds of Formula I6 to I15 and their production are described, for example, in EP 1 346 995 A1. Compounds of Formula I16 to I20 and their production are described, for example, in GB 2 240 778.

The compounds of Formula I and their sub-formulas can be produced according to typical methods known to someone skilled in the art, for example, by Suzuki cross coupling—which can also be performed consecutively—of corresponding aromatic boronic acids or boronic acid esters with suitable substituted phenyl compounds. Here, halogen phenyl compounds, in particular, bromine or iodine phenyl compounds are preferred.

In the following Diagram 1, example synthesis paths for the production of compounds of Formula I via Suzuki cross-coupling are sketched. Here, R²¹, R²² and a to d have the meanings specified above, and M stands for Si, Ge, or Sn. Instead of boronic acid ester (—B(O alkyl)₂), the corresponding boronic acids (—B(OH)₂) could also be used. The reactive groups of phenyl compounds (boronic acid and halide) could also be exchanged.

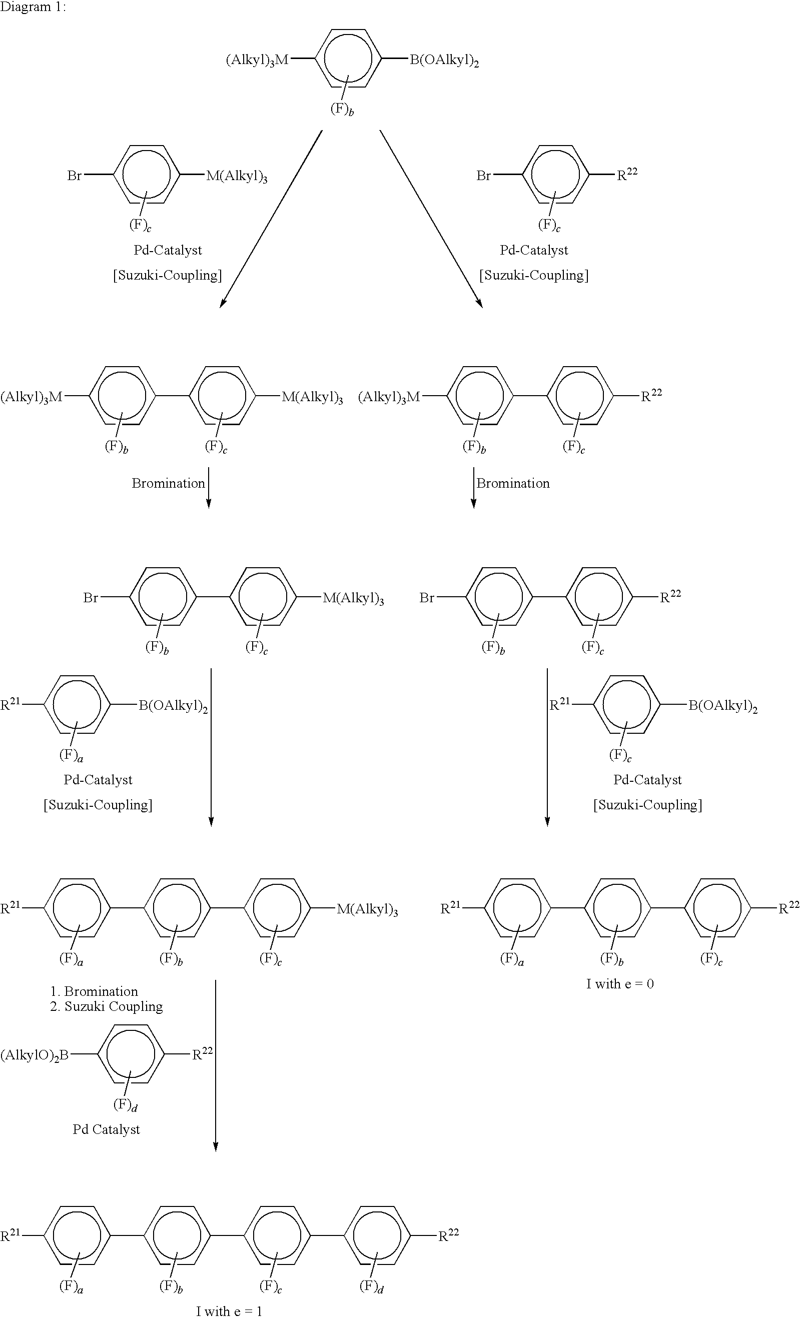

Compounds of Formula I, wherein R¹ stands for —CO—O—R′ or —O—CO—R′ and/or R² for —CO—O—R″ or —O—CO—R″, can also be produced, for example, according to Diagram 2 or 3 or analogously. Therein, R²¹ and a to c have the meanings specified above and R²³ signifies straight-chain alkyl with 1 to 12 C atoms.

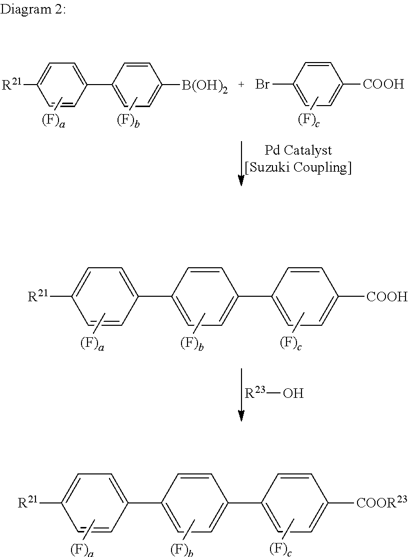

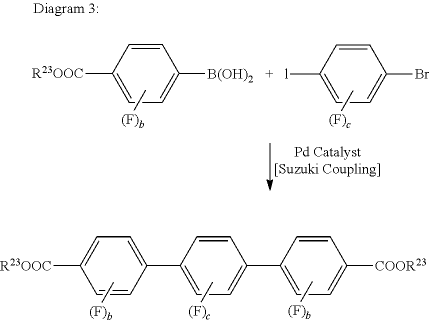

Compounds of Formula I, wherein Z², Z³ and/or Z⁴ stand for —CO—O— or —O—CO— can also be produced, for example, according to Diagram 4 or analogously. Here, R²¹, R²² and a to c have the meanings specified above.

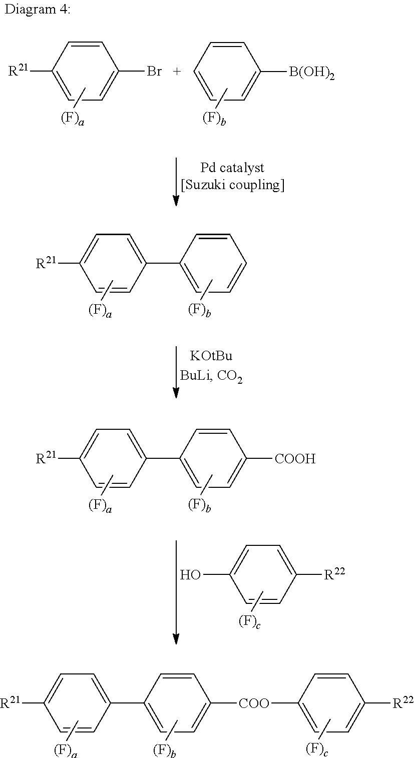

It is conceivable according to the invention, for example, in one possible preferred embodiment of the invention, that two (or also more) compensation films are used for each liquid crystal cell or liquid crystal display or, in one possible, preferred embodiment, only one.

In the first case, the compensation film according to the invention will be used advantageously for the compensation of a VA liquid crystal display (vertically aligned), for the case of two compensation films being used, the range of retardation for each of the films of Ro lies advantageously at 30 to 70, in particular at 40 to 60 nm, that of Rth advantageously at 100 to 160, in particular from 120 to 140 nm, in the case of only one compensation film for the VA display for Ro advantageously at 30 to 70, in particular, 40 to 60 nm, and that of Rth advantageously at 190 to 250 nm, in particular, from 210 to 230 nm (preferred retardation values, preferred retardation ranges).

For the case of the method according to the invention for the production of a compensation film for a liquid crystal display, the method proceeds, for example, in a possible preferred embodiment, as follows:

Another embodiment of the invention relates to a method for the production of optical compensation films of the type according to the invention (as defined above and below or in the claims), wherein one adds at least one compound of Formula I to the mixture used for the production of the compensation films in the scope of a typical method for the production of such films.

Advantageously, processing is performed in one preparation or advantageously step-by-step, e.g., under the use of prepared solutions (for example, under stirring or dispersion) of components, such as the cellulose ester (cellulose acylate), in particular, CAP or advantageously cellulose acetate, to which are added softeners and optionally one or more additives and their mixture, the components of the mixture being used (for a film-casting method in a solvent or solvent mixture), and then by means of a typical method, advantageously the “solution casting” (=film-casting) method on a corresponding film casting machine under controlled under controlled spreading on a suitable substrate, such as a metal band (e.g., made from steel film), and controlled drying to form a compensation film according to the invention, advantageously according to known methods, as described, for example, in US 2005/0045064 A1 that is here incorporated, in this respect, through reference.

It is especially advantageous that, in light of the good solubility of the compounds of Formula I into the solvents/solvent mixtures being used, the addition of these compounds can also be performed in the form of concentrates having an increased concentration relative to the final concentration—this is a preferred variant of the production. For example, the compound or the compounds of Formula I can be added in a solution (that can also include additional additives) concentrated by the factor of 1.05 to 10, such as 1.3 to 5, relative to the final concentration, for example, in-line (in the pump line) under the use of suitable mixers, such as static mixers.

As solvents or solvent mixtures, advantageously cyclic or acyclic esters, ketones, or ethers each with 3 to 12 carbon atoms, or suitable halogenated (in particular, chlorinated) solvents could be used, such as, in particular, dichloromethane or chloroform, advantageously in a mixture with a linear, branched, or cyclic alcohol, in particular, methanol, wherein the alcohol could also be fluorinated. Advantageously, a mixture made from a chlorinated hydrocarbon, such as, in particular, methylene chloride, and an alcohol, in particular, methanol, is used. For the case of mixtures of one of the mentioned non-alcoholic and one of the mentioned alcoholic solvents, their volume ratio lies advantageously at 75 to 25 to 95 to 5, for example, 90 to 10 (non-alcoholic solvent to alcoholic solvent v/v).

Advantageously, a stretching then takes place, in order to be able to set the retardation Ro and Rth well in the preferred range (and simultaneously advantageously to avoid the virtual distortion). The stretching is here monoaxial, without or advantageously with holding perpendicular to the stretching direction or advantageously biaxial, in order to avoid distortion in all directions. The stretching advantageously lies in the range from 1 to 100% (1.01-times to 2-times stretching), for example, in a preferred embodiment of the invention, in the range from 3 to 40% (1.03-times to 1.4-times stretching), with respect to the original length or width of the compensation film. The biaxial stretching can be performed simultaneously or in separate steps. The compensation film drawn from the band is stretched first longitudinally and then laterally and then completely dried or, for non-continuous production of the first completely dried and wound film, in a separate processing step first stretched longitudinally and then laterally or simultaneously.

The film is stretched at room temperature or advantageously at temperatures that are elevated relative to room temperature, wherein the temperature is advantageously not higher than the glass transition temperature of the film material. The film could be stretched under dry conditions. For the longitudinal stretching, the film could be stretched by rolling, for example, in that the velocity of the drawing is slower than that of the rolling, and without or advantageously with lateral holding (for example, by grippers). Alternatively, a separate stretching could be performed in a stretching machine.

In order to achieve good combining (primarily, improved adhesion) with an adhesive for the lamination of polarizer layers (in particular, on PVA base), the resulting protective film is advantageously partially hydrolyzed in another step, in order to increase the hydrophilic properties at the surface, for example, by means of an aqueous base, such as an alkali metal hydroxide, in particular, KOH or NaOH, at temperatures in the range from 0 to 80° C., e.g., at approximately 50° C., wherein the hydrolysis can last, for example, 0.1 to 10 minutes, in one possible, preferred variant, e.g., 1 to 3 minutes. One or more washing steps follow, e.g., with water of suitable purity, and then a drying step.

The film can then be stored optionally after the application of adhesive and protective layers and optionally after cutting in a flat or rolled shape.

A polarizer plate according to the invention includes two transparent protective films and a polarizer membrane in-between. An optical compensation film according to the invention can be used as one of the protective films or can be deposited on one of the protective films. A conventional cellulose acylate, in particular, cellulose-C₁-C₇ alkanoate, in particular, CAP or advantageously cellulose acetate film, can be used as the other protective film (or for both protective films).

As the polarization membrane, for example, iodine-containing polarization membranes, polyene-based polarization membranes, or polarization membranes including dichroic dyes could be used. Iodine-containing and polarization membranes containing the dyes are produced for films made conventionally from polyvinyl alcohol. The transmission axis of the polarizer membrane is placed essentially perpendicular to the stretching direction of the film according to the invention.

The slow axis of the compensation film can be aligned essentially perpendicular or essentially parallel to the transmission axis of the polarizer membrane.

For the production of the polarizer plate, the polarizer membrane and the protective films are (usually) laminated with an aqueous adhesive, wherein the protective films (of which advantageously one can be a compensation film according to the invention directly) are saponified at the surface advantageously as described above.

For the production of circular-polarizing polarizer plates, a compensation film according to the invention can also be placed so that the slow axis of the compensation film is aligned essentially at an angle of 45 degrees to the transmission axis of the membrane (for the case of “essentially perpendicular,” that is, different from a right angle, for the case of “essentially parallel,” different from)0°.

“Essentially” advantageously means that a preceding angle can deviate from an angle named above by 5 degrees, for example, by 4 degrees, in particular, by 2 degrees.

The thickness of a compensation film according to the invention advantageously lies in the range of 20 to 150 μM, in particular, of 30 to 100 μm.

For the production of a liquid display, according to typical methods, two polarization plates produced as above are used with a total of one or two compensation films according to the invention for the production of transmission-type or reflection-type liquid crystal displays. The compensation film(s) according to the invention is or are placed between one of the liquid crystal cells and one or both of the polarizer plates.

The liquid crystal cells here operate advantageously according to the VA (“vertically aligned,” including MVA=“multidomain VA”), OCB (“optically compensated bend”), or TN (“twisted nematic,” including STN=“super twisted nematic,” DSTN=“double layer STN” technology, or HAN=“hybrid aligned nematic”) principle (the VA principle is used very often in large TFT liquid crystal displays and is therefore especially preferred) or also according to the IPS principle (“in plane switching”=field parallel to the surface of the display).

LCD stands for Liquid Crystal Display—a monitor based on liquid crystal technology. Backlighting is here linear polarized by a polarization filter, passes a liquid crystal layer that rotates the polarization plane of the light, e.g., as a function of the desired brightness, and is output again through a second polarization filter. Together with driver electronics, color filters, and glass panes, these components form the so-called “panel.”

TFT (thin film transistor) designates the active matrix variant of LCD panels typical today in desktop monitors and in notebooks, wherein each pixel is driven by a separate transistor. In contract, passive matrix displays have control electronics only at the edge; the individual pixels are switched by row and column.

They are therefore significantly slower in image formation and are used predominantly in small devices, such as mobile telephones, portable digital video devices, or MP3 players due to their lower power consumption. The terms LCD and TFT monitor have often been used synonymously in the meantime, although strictly speaking they are different.

The panel types differ essentially by the type of alignment of the liquid crystals between the substrates of the liquid crystal cells. In TN panels (twisted nematic), the liquid crystal molecules are aligned without an electric field parallel to the surface of the substrate, wherein its preferred direction in the direction perpendicular to the surface has a helical twist and are aligned, when a voltage is applied, in the direction of the electric field applied perpendicular to the surface. They exhibit a relatively high viewing angle dependency that can be only partially reduced with compensation films. They exhibit a not very fast switching response.

For the case of in-plane switching (IPS), the liquid crystal molecules are aligned parallel to the substrate surface, but not twisted. The liquid crystal cell has an electrode layer on only one of the substrates. Therefore, when a voltage is applied, an electric field is generated in the direction parallel to the substrate surface, wherein this electric field reorients the liquid crystal molecules within the panel surface. The contrast is therefore significantly less dependent on viewing angle than in TN panels. However, the viewing angle dependency of the color representation was also reduced first by the improved S-IPS and dual-domain-IPS technology. Due to the weak fields, the switching times were initially very long, but current variants can definitely keep up with fast VA panels.

The liquid crystal molecules in VA panels (vertically aligned) are aligned essentially vertical to the substrate surface in the field-less state and possess negative dielectric anisotropy, so that when the electric field is applied between the substrates, they are reoriented in a direction parallel to the surface. Because VA panels do not pass light without an applied voltage, they achieve a deep black and thus very high contrast values. Sub-types include MVA (multi-domain VA), PVA (patterned VA), and ASV (advanced super view). These divide the cells additionally into regions with different preferred direction and therefore achieve large viewing angle stability. VA panels distinguish themselves, in particular, through short switching times, so that they and their production in the scope of the invention are preferred.

Suitable arrangements are known to someone skilled in the art; the variants named in the present application in the introduction, in the rest of the description, or in the drawings and claims are to be understood only as examples and should not limit the scope of the invention.

Additional additives (added, for example, in the production of the solution or the dispersion of the components) will be or can be added to a compensation film according to the invention, such as, softeners, dispersion agents, pigments, dyes (preferred), UV absorbers, fillers, inorganic polymers, organic polymers, anti-foaming agents, lubricants, antioxidants (such as, hindered phenols, hindered amines, phosphorous-based antioxidants, sulfur-based antioxidants, oxygen scavengers or the like, for example, in a quantity of 0.1 to 10 wt. %), acid scavengers (e.g., diglycidyl ether of polyglycols, metal epoxides, epoxidized ether condensation products, diglycidyl ether, e.g., of bisphenol A, epoxidized unsaturated fatty acid esters, epoxidized vegetable oils or the like, for example, in a quantity of 0.1 to 10 wt. %), radical scavengers, means for increasing the electrical conductivity, thickening means, anti-bleaching means, preservation means, chemical stabilizers, such as sterically hindered amines (such as 2,2,6,6 tetraalkyl piperidines) or phenols, IR absorbers, means for setting the index of refraction, gas-permeability-reducing agents, water-permeability-reducing means, antimicrobial agents, anti-blocking means (especially preferred, also designated as matting means) that allow, for example, good separation of protective films that are set one on the other, e.g., (half) metal oxides, such as silicon dioxide, titanium dioxide, zirconium oxide, calcium carbonate, kaolin, talcum, calcined calcium silicate, hydrated calcium silicate, aluminum silicate, magnesium silicate, or calcium phosphate, small inorganic particles based on phosphoric acid salts, silicic acid salts of carboxylic acid salts, or small cross-linked polymer particles, for example, in a quantity of 0.001 to 5 wt. %, other stabilizers than those already mentioned or the like, or mixtures or two or more such additives. Such additives are known to someone skilled in the art for the purposes of the production of compensation films for polarizers in liquid crystal displays. The total quantity of all such additional additives being used advantageously lies at 0.1 to 25 wt. %. Above, wt. % information relates to the mass of the compensation film material.

As softeners, typical softeners can be used, such as aliphatic dicarboxylic acid esters, e.g., dioctyl adipate, dicyclohexyl adipate, or diphenyl succinate, esters, and/or carbamates of unsaturated or saturated alicyclic or heterocyclic dicarboxylic or polycarboxylic acids, such as di-2-naphthyl-1,4-cyclohexane dicarboxylate, tricyclohexyl tricarbamate, tetra-3-methylphenyl tetrahydro furane-2,3,4,5-tetracaroxylate, tetrabutyl-1,2,3,4-cyclopentane tetracarboxylate, triphenyl benzol-1,3,5-cyclohexyl tricarboxylate, 1,2-cyclohexane dicarboxylic acid diisononylesters, triphenyl benzol-1,3-5-tetracarboxylate, phthalic acid-based softeners apart from those of Formula I, such as diethyl, dimethoxyethyl, dimethyl, dioctyl, dibutyl, di-2-ethylhexyl, or dicyclohexyl phthalate, bis(2-propylheptyl)phthalate, dicyclohexyl terephthalate, methyl phthalyl-methylglycolate, ethyl phthalyl-ethyl glycolate, propyl phthalyl-propyl glycolate, butyl phthalyl-butyl glycolate, glycerine esters, such as glycerine triacetate, citric acid-based softeners, such as acetyl trimethyl citrate, acetyl triethyl citrate, or acetyl butyl citrate, polyether-based softeners, or advantageously (due to improved, especially up to synergistic effectiveness with the softeners of Formula I, but also due to environmental compatibility and good processibility, phosphoric acid-based softeners, such as triphenyl phosphate (very preferred), triorthocresylphosphate, biphenyl diphenyl phosphate, butylene-bis(diethyl phosphate), ethylene-bis(diphenyl phosphate), phenylene-bis(dibutyl phosphate), phenylene-bis(diphenyl phosphate), phenylene-bis(dixylenyl phosphate), bisphenol A-diphenyl phosphate, diphenyl-(2-ethylhexyl)-phosphate, octyldiphenyl phosphate, or triethyl phosphate.

The total percentage of softeners in a compensation film according to the invention, with respect to its mass, advantageously lies in the range of 5 to 15 wt. %, in particular, in the range from 8 to 13 wt. %, for example, at 10 to 12 wt. %.

UV absorbers are selected from typical UV absorber materials that advantageously absorb in the range of UV-A, UV-B, and UV-C radiation (and advantageously in the visible range above 400 nm wavelength of electromagnetic radiation no more than 10% absorption, advantageously no more than 0.5% absorption, in particular, no more than 0.2% absorption). Examples here are:

Typical UV absorber materials to be used are, advantageously, Tinuvin 326® (2-tert-butyl-6-(5-chloro-benzotriazol-2-yl)-4-methyl-phenol=2-(5-chlor(2H)-benzotriazol-2-yl)-4-(methyl)-6-(tert-butyl)phenol=“bumetrizole”) or Tinuvin 327® (2,4-di-tert-butyl-6-(5-chlorbenzotriazol-2-yl)-phenol), both by Ciba Specialty Chemicals AG, Basel, Switzerland, Uvinul 3049® (2, 2-dihydroxy-4,4-dimethoxybenzophenone; BASF AG, Lugwigshafen, Germany), Uvinul D-50® (2,2′,4,4′-tetrahydroxybenzophenone; BASF AG) or mixtures of two or more of these UV protection additives, or, in particular, Tinuvin 326® alone.

IR absorbers can be added to a compensation film for adapting the retardation values at certain wavelengths, for example, in a quantity of 0.01 to 5 weight percent, advantageously 0.02 to 2 weight percent, very preferred from 0.1 to 0.5 weight percent with respect to the mass of the compensation film. Examples for corresponding IR absorbers are inorganic or advantageously organic IR absorbers, such as cyanine dyes, metal chelates, aluminum compounds, diimmonium compounds, quinones, squarylium compounds, and methine compounds, in particular, materials from the field of photosensitive materials from silver halide photography. IR absorbers advantageously exhibit absorption in the range of 750 to 1100 nm, in particular, from 800 to 1000 nm.

Preferred embodiments of the invention are given from the claims and especially from the independent claims, which is why the claims are here incorporated into the description by reference.

Especially preferred embodiments of the invention relate to optical compensation films that include one or more of the compounds of Formula I named in the examples, advantageously monoaxial or, in particular, biaxial stretched compensation films that have, in particular, the stretching ratios named above as preferred; wherein the retardation values Ro and Rth are advantageously set to the values named above as preferred.

### DESCRIPTION OF THE DRAWINGS

FIG. 1 shows Ro and Rth values of compensation films according to the invention for different stretching—the elliptically specified preferred target regions for Ro and Rth are actually to be imagined lying within the maximum extent of the ellipses perpendicular to their longitudinal axis, but no rectangles were drawn, because these would be harder to see. They are also not absolutely limiting. Both relate to a concept for the construction of liquid crystal displays in which two compensation films are used (alternatively, one could also be used, wherein then the very preferred Rth values lie in the range specified above in the description).

For illustration, FIG. 2 shows a possible, non-limiting example for the construction of a liquid crystal display (schematically in the cross section as a cutout).

1=analyzer (polarizer plate); 2=biaxial compensation film with slow axis in the plane of the film and parallel to the plane of the paper; 3, 4, and 5 liquid crystal cells; 6 biaxial compensation film with slow axis in the plane of the film and perpendicular to the plane of the paper; and 7=polarizer plate.

The examples below illustrate the invention, without restricting its scope:

If not explicitly noted differently, in the present application, all of the specified values for temperatures, such as, for example, the melting point T(C, N), the transition from the smectic temperature (S) to the nematic (N) phase T(S, N), and the clarification temperature T(N, I) are specified in degrees Celsius (° C.). Fp means melting point, Kp means clarification temperature. Furthermore, K=crystalline state, N=nematic phase, S=smectic phase, and I=isotropic phase. The information between these symbols represents the phase transition temperature in ° C.

Description of Measurement and Operating Methods being Used:

### A) Determination of Optical Retardation of Transparent Films (Rth and Ro Value)

A double refraction measurement device Exicor 150 AT from Hinds Instruments, Inc., Hillsboro, Oreg., USA is used.

### a) Sample Preparation

From a strip of film (across the width), 3 samples Left/Middle/Right are cut out; here the casting direction (MD) is marked in one corner of the pattern. During sampling, its preparation, but also across the entire measurement process, attention must be paid, in particular, that the film is protected from contaminants, such as dirt, dust, etc., and primarily from scratching. Such defects could have negative effects on the measurement result.

### b) Measurement

The samples are placed individually on the tilt table and first oriented so that the casting direction is perpendicular to the support wires. The sample is covered with an aluminum plate (with 2 notches). Here, the smaller, round hole must be free from film. The angle must equal 0±1° for casting films and 0±3° for hand casts; in order to realize this, the film is rotated until, through additional measurements, the desired angle is reached. For greater variance of the angle (primarily for hand casts), the angle mean value can be controlled by means of the setting: <Graph type normal, Retardation angle->Statistics->Angle->Mean>. It must be measured until the mean equals 0±1° for casting films or 0±3° for hand casts. The film edge can be fixed with adhesive strips on the support wire, in order to prevent slippage/twisting of the sample before the beginning of the actual measurement. To be completely certain, alternatively, the actual measurement spot could also be marked. The measurement spot is the rectangular middle notch. Before the measurement, the refractive index must be known. The refractive index can be changed by means of <Configuration®System Parameters®Sample Refractive Index>.

After the first partial measurement, a window opens: “ready to scan oblique angle,”<with angle display at 30°>, then set the tilt table to 30° and confirm with “ok,” the measurement is continued. When the measurement is complete, the Ro value can be read by means of: Graph type “normal” and “retardation magnitude and angle,” the Ro mean by means of Statistics->Magnitude/Mean>. The R30 value can be read by means of “Graph type” and “oblique”-retardation magnitude and angle”->statistics->mean>. The Rth value can be calculated with the following formula: (VBR+IBR/2)*d*1000 or by means of the table “Calculation Rth” that is located on the desktop (screen) of the computer of the Exicor 150 AT.

### c) Accuracy of the Method

Measurement range: 0-700 nm; reproducibility: ±0-3 nm (R0<30 nm) or ±1% (R0>1 nm); measurement accuracy/resolution: 0.1 nm.

### d) Supplementary Information

Calibration: once per day or after each restart of the device, PC, or software, the basic settings are set with an air measurement (here no film or anything else may be located on the tilt table) by means <System Parameters®Sample®Update Offsets>. The retardation value should equal 0.00xx for the air measurement. One per week, the device is also tested with the Hinds standard (film strip in black holder). For this purpose, the standard is placed on the tilt table and the measurement is started. A value of 12.5±1 nm should be produced.

### B) Determination of Durability

The durability tests are performed at 60° C./95% relative humidity in the climatic exposure test cabinet or at 80° C. in the drying cabinet at a lower relative humidity for more than 500 h or 1000 h.

### a) Measurements

(i) Thickness measurement: the thickness of each hand cast is measured by measuring by a thickness sampler with one measurement surface ground flat and one spherical measurement surface on the basis of DIN 53379, wherein testing is performed for contaminants (such as dust) before the measurement of the sample body, attention must be given that no bulging causes a measurement error and the upper measurement surface is placed in contact without impacts. Before and after each measurement, the zero point of the measurement device is inspected. Measurement points have a spacing of 2-3 cm. The thickness of the sample body is specified as an arithmetic means of 5 individual measurements for each sample.

### (ii) Specification for Measurement of Haze and Transmission:

For the measurement, a light image strikes a sample and enters into an integrated ball. The light distributed uniformly from the matte-white coating of the ball wall is measured in a detector. The total transmission is determined for a closed ball outlet; the haze is determined for an open ball outlet. A ring sensor in the outlet opening measures the image sharpness. The measurement is actually performed with a Gardener BYK Haze-Guard plus 4725 device (Byk Gardner GmbH, Geretsried, Germany). The sample is lighted with vertical illumination and the transmitted light is measured photoelectrically in the integrated ball (=°/diffuse geometry). The spectral sensitivity is adapted to the CIE standard spectral value function y under normal light C. The measurement device corresponds to the standards ASTM D-1003 (standard test method for haze and light transmission of transparent plastics) and ASTM D-1044 (standard test method for the resistance of transparent plastics against surface abrasion).

(iii) Optical evaluation of the surface (migration of additives, etc.)
(iv) Ro and Rth measurement as above.

### (v) Execution

For the measurements, 2*5 cm large samples (10 cm²) are cut out from each pattern and measured under the conditions named above. The sample is always inserted into the photometer in the same way, so that the measurement point is always the same over the duration of the durability test.

After the optical evaluation of the surface of the hand casts, the haze and transmission are measured with the Gardener device and the measurement spot is plotted. The determination of the Ro and Rth values is also performed in this measurement spot.

Then the 2*5 cm large samples are suspended in the climatic exposure test cabinet or the drying cabinet and the measurements are repeated after ca. 100, 200, 300, 400, 500, and optionally 1000 h. The haze/transmission measurements are always performed at the drawn measurement spot.

### C) Stretching of the Films

A laboratory stretching machine KARO 4 from Brückner Maschinenbau GmbH, Siegsdorf, Germany is used.

### a) Sample Production

The hand casts described below are cut into 85×85 mm large squares or the sizes named in the corresponding examples. These are characterized in detail in the center of the square by the measurements named below. If not explained below, the description of the measurement methods is found above.

### b) Measurements on the Stretched Samples: Following Measurements are Performed:

Thickness of the film; haze and transmission; retardation Ro and Rth.

### c) General Machine Description and Execution of the Stretching

The laboratory stretching machine is made from a module for sample coating into which the film is placed under ambient conditions, fixed with 4 clips on all 4 sides, and the entire device is then moved into a furnace module for the pre-heating. After the pre-heating, the sample is moved back into the sample coating space and is stretched. After the cooling of the device, the clips can be detached and the sample can be removed.

During the stretching process, the mechanical extent and also the tension can be measured continuously, which allows conclusions to be made on a design of a production system in comparison of different materials (data not shown).

### d) Stretching Process

Different settings of the stretching process are studied:
change of the stretching speed
different stretching temperatures
stretching performed one after the other and simultaneously for a biaxial method

The resulting suitable setting parameters are:
preheating 1 minute at 160° C.
stretching at 160° C.
clip temperature 130° C.
cooling time to ca. room temperature 20 sec (“freezing”)
stretching speed 1% per sec (for asymmetric biaxial 1% per sec and 4% per sec)
stretching mode: monoaxial with neck-in, monoaxial with fixed dimension perpendicular to stretching direction, biaxial symmetric (factor MD different than in TD), biaxial asymmetric (factor MD=factor TD)
degree of stretching 1.0 to 1.3 in casting direction (longitudinal direction, machine direction; MD) or in transverse direction (TD) for monoaxial stretching
degree of stretching 1.0 to 1.3 in TD and 1.0 to 1.3 in different combinations for biaxial stretching.

If not noted differently, the sample is stretched simultaneously at a slow speed of 1% per sec:

### e) Evaluation of Result

First the integrity of the sample after the cooling and the detachment from the clips is inspected visually. The usable surface area of the sample is ca. 60×60 mm for small samples (“s” as small, original size 70×70, can be expanded after the stretching to, e.g., ca. 85×85 mm, according to stretching conditions), 110×110 mm usable surface area according to stretching conditions for large samples (“1” as large, starting size 120 mm×120 mm), the edge region is lost by the effect of the clips. Then the sample is placed between two crossed polarizers and the resulting polarization color is evaluated. If the polarization color is uniform about the center point of the film, the exact measurement spot is defined by means of marking. On the other hand, if the polarization color is not uniform, the sample is discarded.

### f) Measurement of the Stretched Sample

The following measurements are performed:
Thickness of the film at the measurement spot (see above)
Haze and transmission at the measurement spot (see above)
Retardation Ro and Rth at the measurement spot (see above)

If stretching is performed, this is carried out as described above. In the following examples, the stretching is specified as factor in machine direction (MD)×factor in transversal direction (TD), that is, MD×D. Factor 1.0 in TD means that the film is held against the transversal direction. MD×mono means that no holding takes place in the transversal direction (which leads to narrowing=neck-in).

In the following examples, percent information is given in wt. % if not specified otherwise. “my” stands for μm (thickness of the corresponding films), r.h. stands for relative humidity.

### Example 1

### Films According to the Invention and their Production

A 16 wt. % solution of triacetyl cellulose (TAC) (ACETATI S.A., Verbania, Italy, official designation ACEPLAST TLT-HV, acetylyization degree 60.8%) and triphenyl phosphate (TPP) as softener (90:10 w/w of solid) is mixed in methylene chloride/methanol 95/5 (w/w). This is dissolved over night in the rolling cabinet. This coating is then portioned and the additives are added in the concentrations 2.5% or 5% with respect to the solids (TAC+TPP) and furthermore solvents (in order obtain, in turn, 16% coating) and dissolved again over night in the rolling cabinet. Air is removed from these coatings in a water bath and hand casts are produced (cf. details of Example 7) and dried over night at 80° C.

As the compounds to be added according to the invention, one of the following compounds is used:

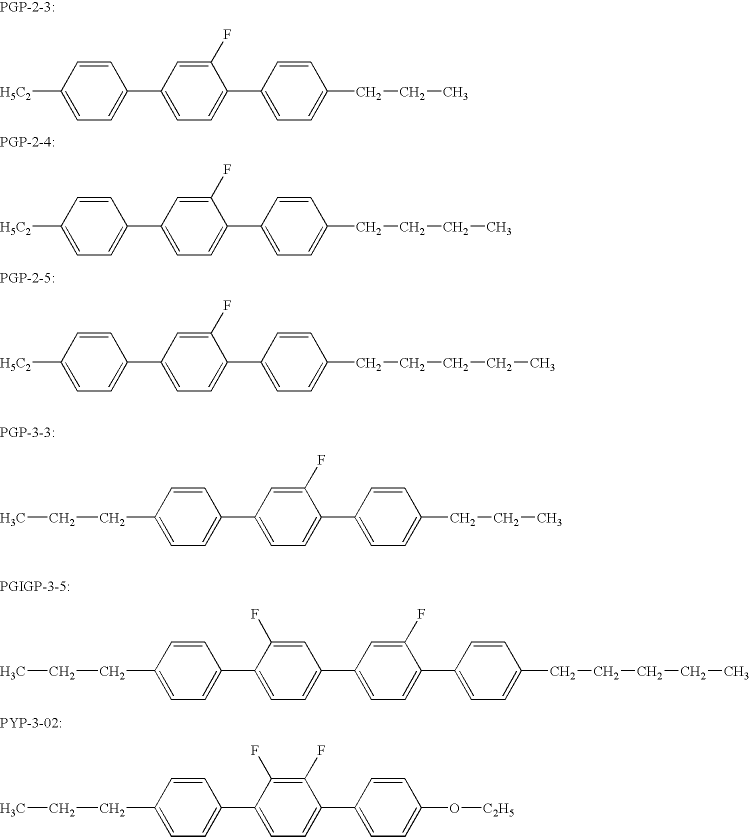

Thickness, haze, and transmission are measured after the drying, as described above.

### Example 2

### Durability

The durability is determined for different films in the dry state (80°) from Example 1 as follows:

TABLE 1
durability for different liquid crystalline rod-shaped additives
a) Conditions 80° C., dry

| PGP-2-3 5% | | | | |
|---|---|---|---|---|
| unstretched (h) | | Transmission | | |
| thickness 79 my | Haze (%) | (%) | Ro (0x) (nm) | Rth (0x) (nm) |
| 0 | 0.25 | 95.3 | 0 | 189 |
| 100 | 0.43 | 94.6 | 0 | 181 |
| 500 | 0.58 | 95.2 | 0 | 187 |
| % deviation after 500 h | 132 | | 0 | −1 |

Condition 80°, dry

| PGP-2-3 5% | | | | |
|---|---|---|---|---|
| 1.2 × mono (h) | | Transmission | | |
| thickness 70 my | Haze (%) | (%) | Ro (1.2 × 1) (nm) | Rth (1.2 × 1) (nm) |
| 0 | 0.6 | 95.2 | 211 | 239 |
| 100 | 0.6 | 94.4 | 148 | 226 |
| 500 | 0.54 | 95.3 | 98 | 170 |
| % deviation after 500 h | −10 | | −53 | −29 |

b) 60°, 95% r.h.

| PGP-2-3 | | | | |
|---|---|---|---|---|
| unstretched 5% | | | | |
| (h) thickness 78 | | Transmission | | Rth (1.2 × 1.2) |
| my | Haze (%) | (%) | Ro (0x) (nm) | (nm) |
| 0 | 0.34 | 95 | 1 | 354 |
| 100 | 3.08 | 94.9 | 1 | 253 |
| 500 | 1.65 | 94.6 | 1 | 137 |
| % deviation after 500 h | 385 | | 0 | −61 |

Condition 60°, 95% r.h.

| PGP-2-3 5% | | | | |
|---|---|---|---|---|
| 1.2 × 1.2 (s) (h) | | Transmission | Ro (1.2 × 1.2) | Rth (1.2 × 1.2) |
| thickness 59 my | Haze (%) | (%) | (nm) | (nm) |
| 0 | 0.12 | 95.3 | 79 | 227 |
| 100 | 0.61 | 95.1 | 70 | 205 |
| 500 | 4 | 95.7 | 51 | 153 |
| % deviation after 500 h | 350 | | −35 | −32 |

Condition 60°, 95% r.h.

| PGP-2-3 5% | | | | |
|---|---|---|---|---|
| 1.2 × 1.2 (l) (h) | | Transmission | Ro (1.2 × 1.2) | Rth (1.2 × 1.2) |
| thickness 61 my | Haze (%) | (%) | (nm) | (nm) |
| 0 | 0.12 | 95.2 | 31 | 172 |
| 100 | 0.51 | 95.4 | 28 | 177 |
| 500 | 0.74 | 95.2 | 18 | 162 |
| % deviation after 500 h | 517 | | −43 | −6 |

Film thickness before stretching: 82 my
c) 80° dry

| PGP-2-4 | | | | |
|---|---|---|---|---|
| unstretched 5% | | | | |
| (h) thickness 76 | | Transmission | | Rth (1.2 × 1.2) |
| my | Haze (%) | (%) | Ro (0x) (nm) | (nm) |
| 0 | 0.25 | 95 | 0 | 181 |
| 100 | 0.32 | 94.1 | 0 | 178 |
| 500 | 0.3 | 95.2 | 0 | 164 |
| % deviation after 500 h | 20 | | 0 | −10 |

80° dry

| PGP-2-4 | | | | |
|---|---|---|---|---|
| 5% 1.3 × mono (s) | | | | |
| (h) thickness 70 | | Transmission | Ro (1.3 × mono) | Rth (1.3 × mono) |
| my | Haze (%) | (%) | (nm) | (nm) |
| 0 | 0.42 | 95.3 | 300 | 253 |
| 100 | 0.48 | 94.4 | 210 | 219 |
| 500 | 0.39 | 95.4 | 104 | 137 |
| % deviation after 500 h | −7 | | −65 | −46 |

Film thickness before stretching 78 my

It is shown that for suitable stretching conditions, Ro and Rth values can easily be achieved that correspond to the preferred ranged named in the description.

### Example 3

### Retardation Values Ro and Rth with and without Stretching at Different Stretching Factor for Films

For TAC films containing 2.5% PGP-2-5 (Table 2a)), 5% PGP-3-3 (Table 2b)) or 5% PGP-2-4 (Table 2c)), the Ro and Rth values are determined after different stretching processes performed as can be seen above and from the table.

TABLE 2
Retardation values at different stretching factors and compositions
a) mono and symmetric biaxial stretching, 2.5% PGP-2-5 as additive,
film thickness before stretching 78 to 80 my,
several tests and means are displayed

| PGP-2-5 | | | | | | |
|---|---|---|---|---|---|---|
| (2.5%) | Ro (nm) | Rth (nm) | Ro (nm) | Rth (nm) | Ro (nm) | Rth (nm) |
| stretching | PGP-2-5 | PGP-2-5 | PGP-2-5 | PGP-2-5 | PGP-2-5 | PGP-2-5 |
| factor Y | Y × mono | Y × mono | Y × Y bi | Y × Y bi | Y × Y bi | Y × Y bi |
| Unstretched = | 1 | 144 | 1 | 147 | 1 | 147 |
| 1 | | | | | | |
| 1.05 | 70 | 128 | 13 | 106 | 15 | 107 |
| 1.1 | 125 | 135 | 26 | 116 | 24 | 121 |
| 1.2 | 198 | 144 | 26 | 112 | | |
| 1.3 | | | | | | |

b) mono, symmetric biaxial, and asymmetric biaxial stretching,
PGP-3-3 as additive

| | | | | | Ro (nm) | Rth (nm) |
|---|---|---|---|---|---|---|
| PGP-3-3 | | | | | PGP-3-3 | PGP-3-3 |
| (5%) | Ro (nm) | Rth (nm) | Ro (nm) | Rth (nm) | asym | asym |
| stretching | PGP-3-3 | PGP-3-3 | PGP-3-3 | PGP-3-3 | MD:TD | MD:TD |
| factor Y | Y × mono | Y × mono | Y × Y bi | Y × Y bi | 1.05:1.0 | 1.05:1.0 |
| (Unstretched) 1 | 0 | 220 | 0 | 216 | 1 | 221 |
| 1.05 | | | 64 | 250 | 60 | 236 |
| 1.1 | | | 103 | 265 | | |
| 1.2 | 10 | 335 | 98 | 275 | | |

Film thickness before the stretching 78 to 80 my.
Here it is shown (last column in b)) that already for simple layer thickness conditions have been found in which especially
preferred retardation values for Ro can be found in the range from 40 to 60 nm and for Rth in the range from 210 to 240 nm.

c) Asymmetric strectching, 2.5% PGP 2-5

| | | | | Rth (nm) | Ro (nm) | Rth (nm) | | |
|---|---|---|---|---|---|---|---|---|
| | Ro (nm) | Ro (nm) | Ro (nm) | PGP2-5 | PGP-2-5 | PGP-2-5 | Ro (nm) | Rth (nm) |
| PGP-2-5 | PGP-2-5 | PGP-2-5 | PGP-2-5 | asym | asym | asym | PGP-2-5 | PGP-2-5 |
| (2.5%) | asym | asym | asym | (MD × TD) | (MD × TD) | (MD × TD) | asym | asym |
| stretching | (MD × TD) | (MD × TD) | (MD × TD) | 1.3 × 1.05 | 1 × 1.2 | 1 × 1.2 | (MD × TD) | (MD × TD) |
| factor | 1.2 × 1 | 1.2 × 1 | 1.2 × 1 | or 1.2 × 1 | (held) | (held) | 1.05 × 1.2) | 1.05 × 1.2 |
| 1 | 1 | 143 | 1 | 143 | 1 | 143 | 1 | 143 |
| 1.05 | 90 | 131 | | | 107 | 120 | | |
| 1.1 | | | 62 | 121 | | | 95 | 140 |
| 1.2 | | | 102 | 125 | | | | |

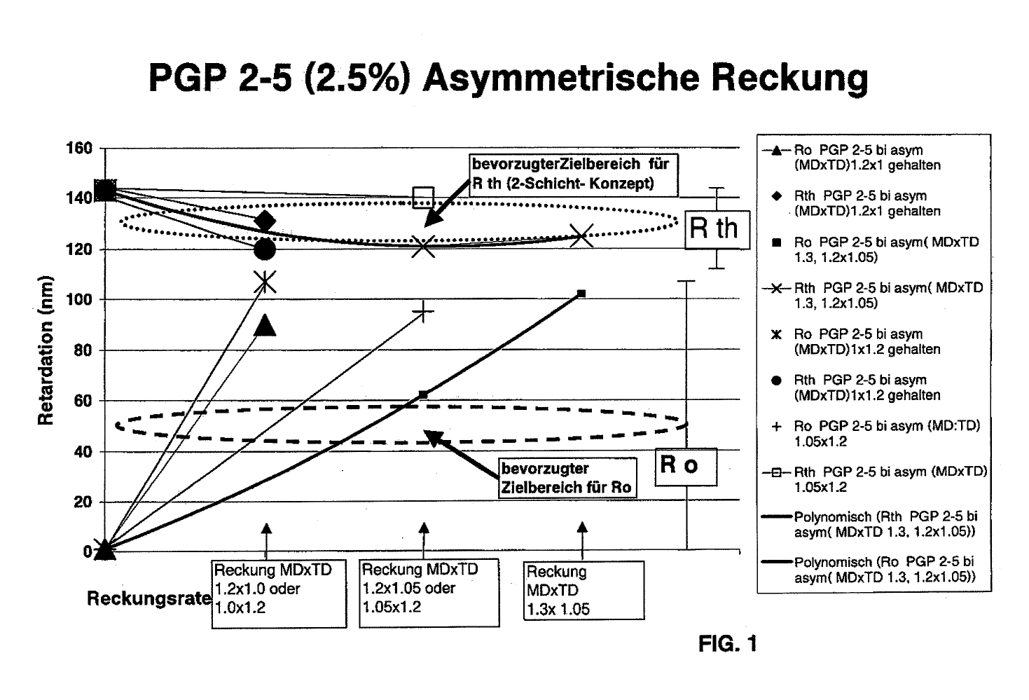

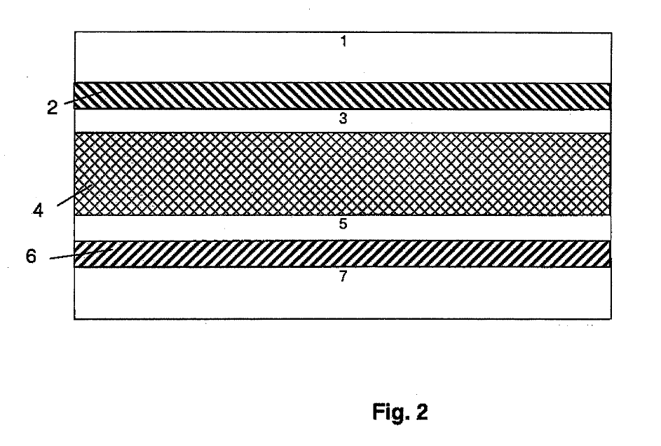

The corresponding data of the bold columns (second table) are shown graphically in FIG. 1 (with partially differing
nomenclature).

It is shown that stretching factor ratios could be found easily in which the films have Ro and Rth values lying in the ranges in FIG. 1 characterized as the “preferred target range” (to be imagined only schematically as an ellipse, is actually rectangular).

For the comparison, the following table shows the Ro and Rth values for TAC films without the addition of compounds of Formula I according to the invention:

TABLE 3
Retardation without compounds of Formula I:

| TAC | monoaxial Ro | monoaxial Rth |
|---|---|---|
| Stretching factor 1 | 1 | 47 |
| (=unstretched) | | |
| Stretching factor 1.2 | 17 | 47 |

The designation “mono” here means that it was not held at the sides, in the case of mono-axial stretching, i.e., neck-in takes place (stretching factor 1.2).

Here, it shows no change in Rth, but a slight change in Ro, which can be explained in that no change occurs in the refractive index in the Z-axis, but in the x and y directions in the plane of the film o.k.

### Example 4

### Determination of the Durability at 60° C., 95% Relative Air Humidity for Unstretched and Stretched Films

The durability (consistency of the retardation values) at 60° C. and 95% relative air humidity is determined for the films named in the table below and produced according to the method named in Example 1.

TABLE 4
durability for specified films
a) non-stretched 60°, 95%

| PGP 2-3 (5%) | | | Ro (nm) | Rth (nm) |
|---|---|---|---|---|
| un-stretched (h) | | | PGP 2-3 | PGP 2-3 |
| 77 my | Haze | Transmission (%) | (unstretched) | (unstretched) |
| 0 | 0.34 | 95 | 1 | 354 |
| 100 | 3.08 | 94.9 | 1 | 253 |
| 500 | 1.65 | 94.6 | 1 | 137 |
| % Deviation after 500 h | 385 | | 0 | −61 |
| PGP-2-4 un-stretched | | | Ro (nm) | Rth (nm) |
| (h) | | | PGP-2-4 | PGP-2-4 |
| 61 my | Haze | Transmission | (unstretched) | (unstretched) |
| 0 | 0.26 | 95 | 2 | 162 |
| 100 | 3.84 | 94.4 | 2 | 167 |
| 500 | 1.69 | 94 | 11.2 | 138 |
| % Deviation after 500 h | 550 | | −50 | −14 |
| PGP-2-5 | | | | |
| 2.5% | | | | |
| (82 μm) un-stretched | | | Ro (nm) | Rth (nm) |
| (h) | Haze | Transmission | PGP-2-5 | PGP-2-5 |
| 0 | 0.28 | 95.2 | 0 | 137 |
| 120 | 0.41 | 95.1 | 1 | 116 |
| 500 | 1.28 | 95 | 0 | 107 |
| | 357 | | cannot be calculated | −22 |
| PGP-3-3 | | | | |
| 5% | | | Ro (nm) | Rth (nm) |
| 81 μM un-stretched (h) | Haze | Transmission | PGP-3-3 | PGP-3-3 |
| 0 | 0.34 | 95.4 | 1 | 212 |
| 120 | 0.67 | 95.3 | 1 | 199 |
| 500 | 0.87 | 95.3 | 1 | 141 |
| % Deviation after 500 h | 156 | | 0 | −33 |
| PYP-3-02 (h) | | | | |
| 5% | | | Ro (nm) | Rth (nm) |
| Thickness 80 my | Haze | Transmission | PYP-3-02 | PYP-3-02 |
| 0 | 0.64 | 95.2 | 0 | 205 |
| 120 | 1.36 | 95.1 | 1 | 185 |
| 500 | 1.73 | 95.3 | 1 | 141 |
| % Deviation after 500 h | 170 | | cannot be calculated | −31 |

b) stretched

| PGP-2-3 (1 b) | | | | |
|---|---|---|---|---|
| (stretched) (h) | | | | |
| 5% | | | Ro (nm) | Rth (nm) |
| Thickness 59 my | | | PGP-2-3 | PGP-2-3 |
| Film size s | Haze | Transmission | (1.2 × 1.2) | (1.2 × 1.2) |
| 0 | 0.12 | 95.3 | 79 | 227 |
| 100 | 0.61 | 95.1 | 70 | 205 |
| 500 | 0.54 | 95.7 | 51 | 153 |
| % Deviation after 500 h | 350 | | −35 | −32 |

Delete here only mean values

| % Deviation after 500 h | 203 | | −22 | −14 |
|---|---|---|---|---|
| PGP-2-3 (stretched) (h) | | | | |
| 5% | | | Ro | Rth |
| Thickness 61 my | | Transmission | PGP-2-3 | PGP-2-3 |
| Film size s | Haze | (%) | (1.2 × 1.2) | (1.2 × 1.2) |
| 0 | 0.12 | 95.2 | 32 | 172 |
| 100 | 0.51 | 95.4 | 28 | 177 |
| 500 | 0.74 | 95.2 | 18 | 162 |
| % Deviation after 500 h | 517 | | −43 | −6 |
| PGP-2-3 (stretched) (h) | | | | |
| 5% | | | | |
| Thickness 63 my | | | Ro | Rth |
| Film size s | Haze | Transmission | PGP-2-4 (1.2 × bi) | PGP-2-4 (1.2 × bi) |
| 0 | 0.15 | 95.2 | 48 | 204 |
| 100 | 0.49 | 95.1 | 39 | 196 |
| 500 | 0.43 | 95.7 | 35 | 173 |
| % Deviation after 500 h | 187 | | −27 | −15 |
| PGP-2-4 (stretched) (h) | | | | |
| 5% | | | | Rth (nm) |
| Thickness 63 my | | | Ro (nm) PGP-2- | PGP-2-4 |
| Film size s | Haze | Transmission | 4 (1.2 × 1.2) | (1.2 × 1.2) |
| 0 | 0.15 | 95.2 | 49. | 199 |
| 100 | 0.61 | 95.4 | 4 | 197 |
| 500 | 0.48 | 95.5 | 41 | 174 |
| % Deviation after 500 h | | | | |
| PGP-2-5 (stretched) (h) | | | Ro (nm) | |
| 2.5% | | | PGP-2-5 Factor | |
| 71 μm | | | stretching | Rth (nm) |
| Film size s | Haze | Transmission | 1.12 × 1.1 | PGP-2-5 |
| 0 | 0.39 | 94.9 | 23 | 108 |
| 120 | 0.51 | 95.1 | 23 | 115 |
| 500 | 0.39 | 95.1 | 24 | 112 |
| % Deviation after 500 h | 0 | | 4 | 4 |
| PGP-3-3 (stretched) (h) | | | | |
| 5% | | | Ro (nm) | |
| 78 μm stretched | | | PGP-3-3 | |
| thickness | | | Factor stretching | Rth (nm) |
| Film size s | Haze | Transmission | 1.05 × 1.05 | PGP-3-3 |
| 0 | 1 | 94.9 | 73 | 246 |
| 120 | 0.78 | 95 | 68 | 287 |
| 500 | 0.67 | 95.1 | 61 | 286 |
| % Deviation after 500 h | −33 | | −16 | 16 |
| PYP-3-02 (stretched) | | | Ro (nm) | |
| (h) | | | PYP-3-01 Factor | |
| 5% | | | stretching | Rth (nm) |
| Thickness 78 my | Haze | Transmission | 1.05 × 1.05 | PYP-3-02 |
| 0 | 0.54 | 95.1 | 48 | 198 |
| 120 | 0.91 | 94.8 | 42 | 144 |
| 500 | 1.3 | 94.8 | 41 | 132 |
| % Deviation after 500 h | 141 | | −15 | −33 |

It shows essential stability of the retardation values also after 500 hours under the rather harsh specified conditions.

### Example 5

### Summary of Retardation Values Obtained for Different Stretching Processes

TABLE 5
Summary of retardation values obtained for different stretching processes

| PGP-2-3 | | Rth (nm) | Ro (nm) | Rth (nm) |
|---|---|---|---|---|
| stretching | PGP-2-3 mono | PGP-2-3 mono | PGP-2-3 mono | PGP-2-3 mono |
| 1 | 1 | 174 | 1 | 197 |
| 1.2 | 220 | 220 | 225 | 198 |
| 1.3 | 284 | 216 | | |
| | Ro (nm) | Rth (nm) | Ro (nm) | Rth |
| | PGP-2-3 bi | PGP-2-3 bi | PGP-2-3 bi | PGP-2-3 bi |
| | Factor info. in | Factor info. in | Factor info. in | Factor info. in |
| PGP-2-3 | left column | left column. | left column | left column |
| 1 | 1 | 174 | 1 | 215 |
| 1.2 | 80 | 227 | 34 | 146 |
| 1.3 | | | | |
| | Ro (nm) | Rth (nm) | Ro (nm) | Rth (nm) |
| PGP-2-4 | PGP-2-4 mono | PGP-2-4 mono | PGP-2-4 mono | PGP-2-4 mono |
| 1 | 1 | 220 | 1 | 214 |
| 1.2 | 233 | 220 | 236 | 177 |
| 1.3 | 294 | 202 | | |

| | Ro (nm) | Rth (nm) | Ro (nm) | Rth (nm) | Ro (nm) | Rth (nm) |
|---|---|---|---|---|---|---|
| | PGP-2-4 bi | PGP-2-4 bi | PGP-2-4 bi | PGP-2-4 bi | PGP-2-4 bi | PGP-2-4 bi |
| | Factor info. | Factor info. | Factor info. | Factor info. | Factor info. | Factor info. |
| | in left | in left | in left | in left | in left | in left |
| PGP-2-4 | column | column | column | column | column | column |
| 1 | 1 | 220 | 1 | 220 | 1 | 196 |
| 1.2 | 49 | 220 | 16 | 128 | 108 | 203 |
| 1.3 | | | | | | |

As the compound of Formula I, PGP-2 is used, 5% content, thickness 78 to 80 my. Mean values from several tests.

### Example 6

### Durability Summarized for Different Additives

The durability of films with different additives of Formula I is tested under the conditions specified in the following table.

TABLE 6
Summary of durability

| | | | | | | |
|---|---|---|---|---|---|---|
| | | | | Change in | Change in | Change in |
| | | | | haze | Ro | Rth |
| | | | Thickness | (relative in | (relative in | (relative in % |
| | | | (μm) | % 0 to | % 0 to | 0 to |
| Additive | % w/w | Stretching | (unstretched) | 500 h) | 500 h) | 500 h) |

a) at 500 h at 80° C., dry:

| | | | | | | |
|---|---|---|---|---|---|---|
| PGP-2-3 | 5 | not | | 385 | ns^{§} | −61 |
| PGP-2-4 | 5 | stretched | | ns^{§} | ns | −10 |
| PGP-2-5 | 2.5 | | 87 | ns | ns | 0 |
| PGP-3-3 | 5 | | 77 | ns | ns | −18 |
| PYP-3-02 | 5 | | 82 | ns | ns | −5 |
| PGP-2-3 | 5 | 1.2 × 1.2 | | 350 | −39 | −19 |
| PGP-2-4 | 5 | 1.2 × 1.2 | | 220 | −22 | 14 |
| PGP-2-5 | 2.5 | 1.2 × 1.2 | 73 | ns | ns | ns |
| PGP-3-3 | 5 | 1.2 × 1.2 | 78 | ns | −100 | −31 |
| PYP-3-02 | 5 | 1.2 × 1.2 | 64 | 140 | −15 | −33 |

b) 500 h 60° 95% r.h.

| | | | | | | |
|---|---|---|---|---|---|---|
| PGP-2-3 | 5 | not | 60 | 385 | ns^{§} | −61 |
| PGP-2-4 | 5 | stretched | 63 | 550 | ns | −14 |
| PGP-2-5 | 2.5 | | 82 | 360 | ns | −22 |
| PGP-3-3 | 5 | | 80 | 160 | ns | −33 |
| PYP-3-02 | 5 | | 81 | 170 | ns | −31 |
| PGP-2-3 | 5 | 1.2 bi | 60 | 350 | −35 | −32 |
| PGP-2-4 | 5 | 1.3 u | 63 | ns | −65 | +190 |
| PGP-2-5 | 2.5 | 1.2 bi | 71 | ns | ns | −20 |
| PGP-3-3 | 5 | 1.2 bi | 72 | ns | −16 | 16 |
| PYP-3-02 | 5 | 1.2 bi | 78 | ns | −56 | −33 |

ns means: not significant

### Example 7

### Films with Additive of Formula I and UV Absorbers

Coatings with a UV absorber as an additional additive in addition to the additive of Formula I specified below are produced.

The production is performed under the use of a coating made from 16 wt. % cellulose triacetate (Acetati, Aceplast TLT-HV) (contents of bound acetyl 60.8%) in methylene chloride/methanol (90/10 v/v) triphenyl phosphate as softener (10/90 w/w with respect to solids). Then it is stored over night in the rolling cabinet. The solution is then portioned and the additives Uvinul 3049® (BASF) (0.64% with respect to solid) and 2.5% PGP 2-5 (with respect to solid) are added. Air is removed from these coatings in a water bath and hand casts are spread by means of a doctor blade (casting gap 650 μm, casting width 220 mm, rolling speed 25 mm/sec), Coatmaster® 509 MC from Erichsen GmbH & Co. KG, Herner, Germany, on a 10 mm glass plate and dried over night at 80° C. and in this way ca. 80 μm thick films are produced. These films are stretched monoaxially under the same conditions as mentioned above. The stretching degree each equals 1.2×1.0.

The following durability values are produced at 60° C./95° C. or 80° C., dry.

TABLE 7

| | Rth (nm) | Rth (nm) |
|---|---|---|
| | (79 my thickness | 79 my thickness |
| | after stretching) | after stretching) |
| Test period | (2.5% PGP-2-5 + UV) | (2.5% PGP-2-5 + UV) |
| (days) | 60° C./95% | 80° C./0% |
| 0 | 142 | 127 |
| 7 | 147 | 131 |
| 14 | 149 | 127 |
| 21 | 150 | 122 |
| 28 | 144 | 119 |
| 35 | 137 | 121 |
| 42 | 171 | 123 |
| | Ro (nm) | Ro (nm) |
| Test period | 18 (PGP-2-5 + UV) | 20 (PGP-2-5 + UV) |
| (days) | 60° C./95% | 90° C./0% |
| 0 | 94 | 63 |
| 7 | 86 | 46 |
| 14 | 89 | 49 |
| 21 | 97 | 57 |
| 28 | 98 | 51 |
| 35 | 97 | 55 |
| 42 | 99 | 51 |

The results show that the addition of a UV absorber has no negative effect on the durability

### Example 8

### TAC Compensation Film with PGP 2-5, Saponified on the Surface

The saponification of the surface of a TAC film is performed with PGP-2-5 (2.5%). There are no significant changes to the optical properties.

Mixture: 16% coating, T220 with 10% TPP, 2.5% PGP-2-5, and 0.64% Uvinul 3049®.

Sample: 7.5×5 cm, stretched 1.3×1.3, 74 μm.

The saponification is performed with 1.5 molar KOH. The film is suspended for 3 min at 50° C. in the aqueous KOH (wetting surface ca. 5×5 cm) and then rinsed with 1 min with distilled water. Then the sample is blown dry with compressed air and measured.

The following table shows the measurement results:

TABLE 8

| | | Original | After saponification |
|---|---|---|---|
| Retardation R₀/Rth | nm | 117/7.2 | 108/6.4 |
| Haze | % | 94.1 | 94.5 |
| Transmission | % | 0.53 | 0.45 |
| (Gardner) | | | |
| UV spectrum (200-600 nm) | | x | x |
| Transmission at 400 nm | % | 52.72 | 52.48 |

Comparison of the spectra before and after saponification: identical.

### Example 9

### Mixture of CAP with PGP-2-5

Procedure for this example: instead of triacetyl cellulose, for the production of a compensation film according to the invention CAP=cellulose aceto propionate from Eastman type CAP 141-20 (Eastman Chemical Co., Kingsport, Tenn., USA: M_{W}=ca. 280,000 g per mol, Mₙ=ca. 80,000 g per mol) is used. The relation of acetate to propionate here equals 75 to 25. The production is performed analogous to Example 1, with the following specifics:

As the additive of Formula I, PGP-2-5 is used. Simple concentrated solutions in standard cellulose aceto propionate coating are used with 6% TPP as a softener and 2.5% PGP-2-5 with respect of the mass (weight) of solids.

The conditions for the production correspond to those named in Example 1. The thickness of the produced films lies at 80 μm. The measurements are performed like for the other films. The following measurement values are given:

TABLE 9

| | Haze | Ro | Rth | Thickness | Refractive index |
|---|---|---|---|---|---|
| CAP + 2.5% PGP-2-5 | 0.23 | 1.7 | 215 | 86 | 1.477 |

It is shown that here relatively high Rth values can be achieved. The advantage is that less additive is needed than in a TAC film or a relatively low layer thickness. Therefore, special suitability is given for compensation in LCD displays by means of only one compensation film (one-layer solution).

### Example 10

### Production of an LCD Display According to the Invention

### a) Production of a Polarizer Plate:

A stretched PVA film is treated with iodine for the production of a polarizer membrane.

A TAC film according to Example 1 with PGP-2-5 as an additive, stretched until producing an Ro from 40 to 60 nm and an Rth from 120 to 140 nm is subjected at the surface to saponification through processing in 1.5 M NaOH at 50° C. and then laminated onto one side of the polarizer membrane by means of a polyvinyl alcohol adhesive.

A commercially available TAC film without an additive of Formula I (Fujitak TD80F®) is likewise subjected analogously to saponification at the surface and laminated onto the opposite side of the polarizer membrane.

The polarizer membrane and the TAC film from Example 1 are arranged so that the fast axis of the membrane and the slow axis of the film are aligned essentially parallel. The polarizer membrane and the TAC film without an additive of Formula I are aligned so that the fast axis of the membrane and the slow axis of the film lie essentially perpendicular to each other.

In this way, a polarizer plate is obtained.

### b) Production of a Liquid Crystal Display:

A pair of polarizer plates and a pair of optical compensation films are removed from a commercially available liquid crystal display (VL-1530S, Fujitsu, Ltd.) that has a liquid crystal cell with vertically aligned (VA) liquid crystal molecules.

Instead of the removed parts, a polarizer plate obtained according to a) is laminated on each side (backlight side and viewing side) with an adhesive, so that the TAC film with the additive (compensation film) comes to lie on the inside (in the direction of the liquid crystal cell). The polarizer plate on the viewing side is arranged so that the fast axis is aligned longitudinally, while the plate is arranged on the back side, so that the fast axis is aligned laterally (“cross-nicol” positions).

The viewing angle of the produced liquid crystal display is determined by a measurement device (EZ Contrast 160D, ELDIM).

### Example 11

### Production of a Casting Film from Cellulose Triacetate with a Thickness of 80 μm under Addition of an Additive Concentrate

Under stirring, cooling, and heating cycles, a homogenous solution is produced from 2381 kg cellulose triacetate (Eastman/CA-435-40S, DS>>2.96), 13483 kg dichloromethane:methanol mixture (9:1 vol.), 324 triphenyl phosphate and 35.7 kg UV absorber (Uvinul 3049®, BASF) and this solution is heated to ca. 40° C. for removing gases, By means of intermediate tanks, the solution is filtered through several filters made from metal fiber matting (pore size 15-17 μm or 5-7 μm) at increased pressure and temperature, and then mixed in-line (in the pump line by means of a static mixer) with a similarly filtered addition solution that contains, in addition to the materials mentioned above, another dichloromethane:methanol mixture (9:1 vol.), an antiblocking additive, and an antistatic additive. The mixing ratio is set so that, in the dry film, 0.2-0.5 (0.38) wt. % antiblocking additive is contained.

In addition, at room temperature through 2 hours of stirring, 207 kg of a solution of the additive PGP-2-5 is produced in which 5.6 wt. % additive, 1.26% cellulose acetate, 0.14% triphenyl phosphate, and 93% dichloromethane:methanol mixture (9:1 vol) are located. This solution is continuously fed to the cellulose acetate solution above after filtration and mixed in-line.

After heating to 31° C., the solution is cast under a dichloromethane-methanol atmosphere with a dichloromethane vapor content of ca. 3-15 vol. % (Haube/BK) and a temperature of 29° C. to the required thickness (casting gap ca. 600 μm) on a polished, endless steel band of 28 m length and ca. 1.45 m width revolving at 2 m/min. The temperature in the band channel is increased step by step to ca. 90° toward the pick-off point, then the film is picked up there and the formed film is guided into the drying cabinet region. Then the film is dried over a length of ca. 90 m step by step from ca. 40° C. in the starting region to ca. 90° C. for an increasing temperature and finally cut and wound after the cooling to 1336 mm width. After setting a stationary operating state, an 80 μm thick film with a solvent moiety content of ca. 0.7 wt. % and an optical delay (in plane) Ro of ca. 1 nm and (out of plane) Rth of ca. 130 nm is obtained. This film roll is further processed in a subsequent stretching process, as described in the description of the measurement and operating methods.

### Example 12

### Production of PGP-2-5

The compound PGP-2-5 is produced as follows:

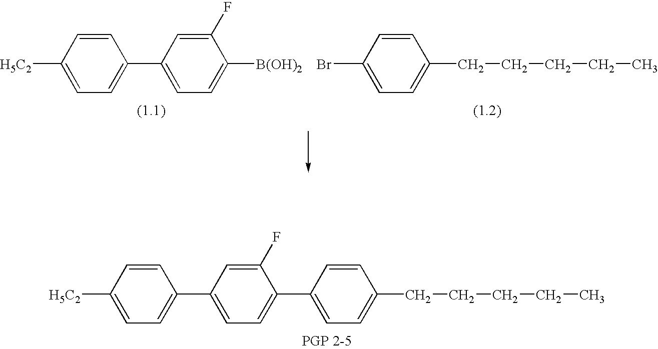

6.7 kg (29.4 mol) 1-bromine-4-n-pentyl benzol (1.2), 15 kg di-sodium tetraborate decahydrate, 100.5 g bis(triphenylphosphine)palladium(II) chloride and 21.75 g hydrazinium hydroxide are placed in 10 L water and 10 kg THF and heated to 60° C. while stirring. Then within 30 min a solution of 7.5 kg (26.7 mol) of boronic acid (1.1) is added into 18 kg THF and then stirred for 1.5 h. The aqueous phase is separated, the solution is concentrated to a residue and this is dried. The residue is dissolved in 25 L acetonitrile and 10 L ethanol at 50° C. and crystallizes through cooling to 0° C. over night. The crystals are washed and dried with cold ethanol. After column chromatography in n-heptane, filtration, and repeated washing, 7.8 kg (22.4 mol, 84%) of compound PGP-2-5, GC: 97%, liquid crystalline phase response: K 55 N 172.2 l is obtained.

### Example 13

### TAC Compensation Film with PGP-5 Amine

A solution consisting of 14.7 wt. % triacetyl cellulose (TAC), 2% triphenyl phosphate (TPP) as softener in methylene chloride, the compound (A) is added in a concentration of 2.5 wt. % (with respect to the solids TAC and TPP) and dissolved over night. With this solution, as described in Example 1, a 65 my thick film is produced on a glass substrate. The Rₜₕ value of the unstretched film equals 160 nm.

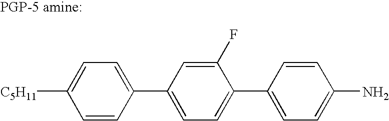

1. Optical compensation film on a cellulose acylate base for liquid crystal displays, wherein the film includes, as an additive, at least one aromatic compound with at least two aromatic rings, wherein the aromatic compound involves such a compound of Formula I: 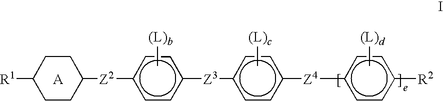
wherein
R¹ signifies straight-chain alkyl or alkoxy with 1 to 12 C atoms, wherein one or more CH₂ groups can also be replaced by —O—, —S—, —CO—, —CO—O—, —O—CO—, —O—CO—O—, —NR⁴—, —CO—NR⁴—, —NR⁴—, —CO—NR⁴—, —NR⁴—CO—, so that O and/or S atoms are not linked directly with each other, wherein one or more H atoms could also be replaced by F,
R² signifies CN, F, Cl, or straight-chain alkyl or alkoxy with 1 to 12 C atoms, wherein one or more CH₂ groups can also be replaced by —O—, —S—, —CO—, —CO—O—, —O—CO—, —O—CO—O—, —NR⁴—, —CO—NR⁴—, —NR⁴—CO— so that O atoms and S atoms are not linked to each other directly, and wherein one or more H atoms can also be replaced by F,
R⁴ signifies hydrogen or C₁-C₇ alkyl,
the ring 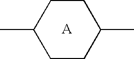
signifies either 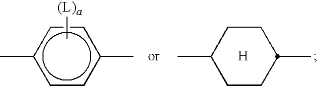
Z²-Z⁴ each signify, independent of each other, —CO—O—, —O—CO—, —CONR⁴—, —NR⁴CO—, —CH₂O—, —OCH₂—, —CH₂S—, —SCH₂— or a simple bond,
the moieties L signify, independent of each other, H, F, or one of the moieties L also signifies Cl, and a, b, c, and d each signify, independent of each other, a whole number 0, 1, or 2, and e signifies a whole number 0 or 1.

2. Optical compensation film according to claim 1, comprising as the compound of Formula I, at least one such compound of the formulas: 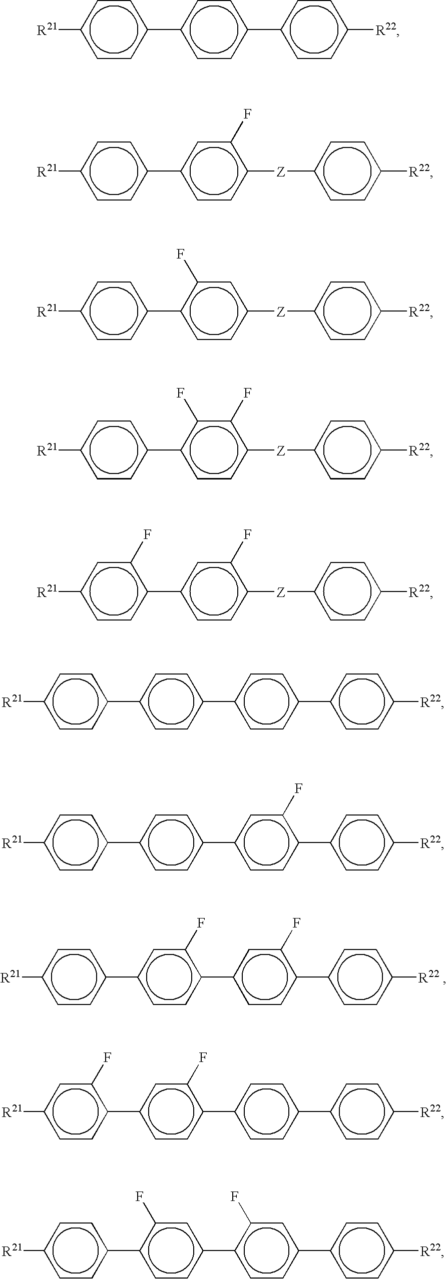 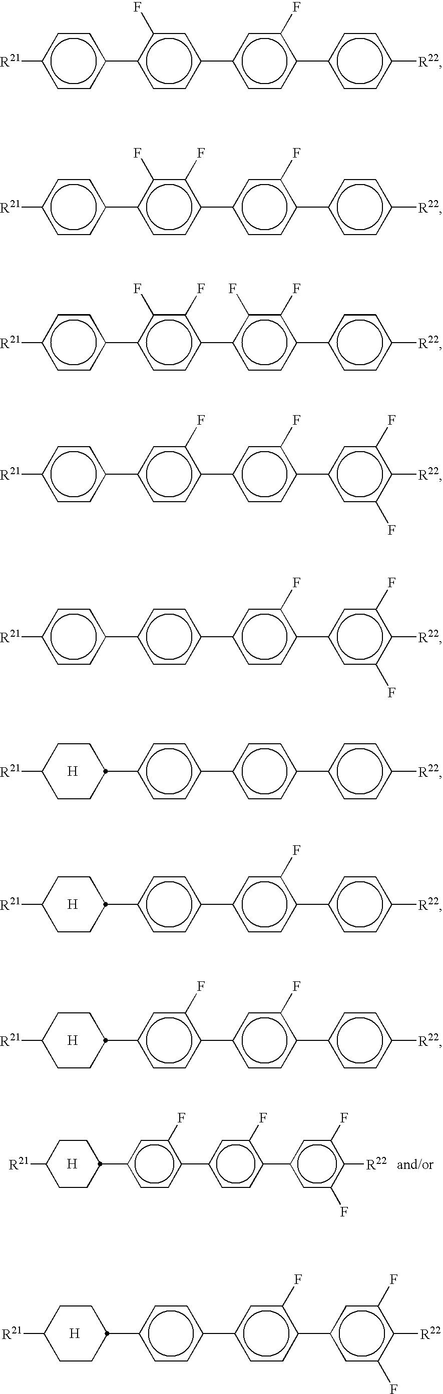
wherein R²¹ signifies R¹ and R²² signifies R², R¹, R², Z¹, and Z⁵ have the meanings named in Formula I in claim 1 and Z has one of the meanings specified in claim 1 for Z³ in Formula I, advantageously —CO—O— or a simple bond, very especially preferred a simple bond.

3. Optical compensation film according to claim 2, wherein it includes one or more compounds of Formula I in a weight percentage of 0.5 to 10 weight percent with respect to a total weight of the compensation film.

4. Optical compensation film according to claim 2, wherein it includes one or more compounds of Formula I in a weight percentage of 2 to 6 weight percent with respect to a total weight of the compensation film.

5. Optical compensation film according to claim 2, wherein it has a thickness from 20 to 150 μm.

6. Optical compensation film according to claim 2, wherein it has a retardation value Ro from 30 to 70 nm and a retardation value Rth from 100 to 160 nm, wherein Ro stands for the retardation value in a direction of the plane and Rth stands for the retardation value in a direction of a thickness of the optical compensation film.

7. Optical compensation film according to claim 6, wherein that it has a retardation value Ro from 40 to 60 nm and a retardation value Rth from 120 to 140 nm.

8. Optical compensation film according to claim 2, wherein it has a retardation value Ro from 30 to 70 nm and a retardation value Rth from 190 to 250 nm.

9. Optical compensation film according to claim 8, wherein it has a retardation value Ro from 40 to 60 nm and a retardation value Rth from 210 to 230 nm.

10. Optical compensation film according to claim 1, wherein as the compound(s) of Formula I, it includes one or more compounds selected from the following group: 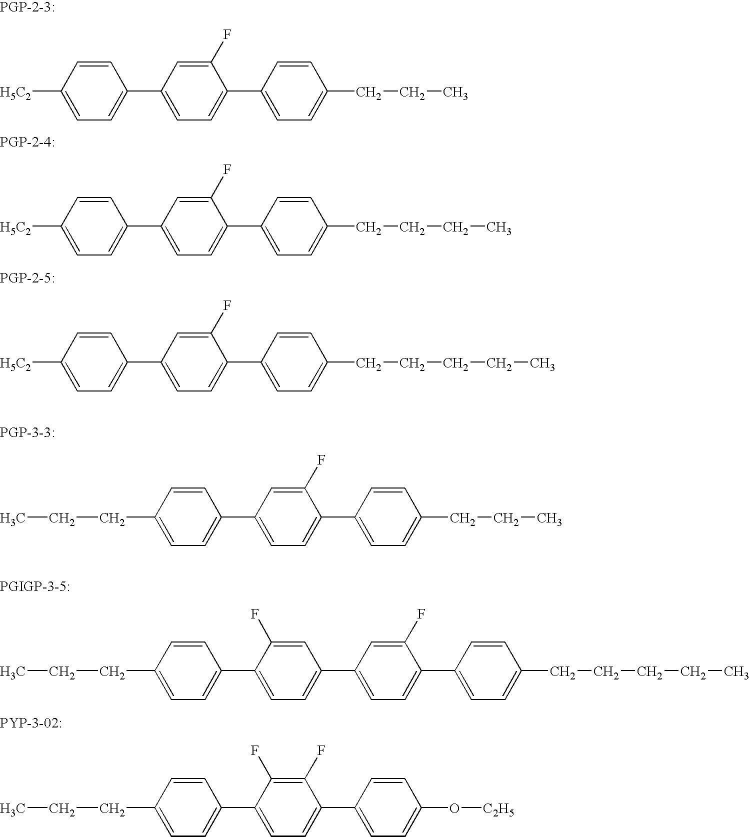
and PGP-5-amine:

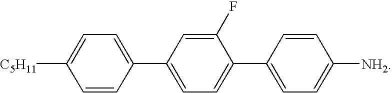

11. Optical compensation film according to claim 1, wherein the cellulose acylate used as a basis involves at least one of a cellulose aceto propionate (CAP) or a cellulose acetate.

12. (canceled)

13. A polarizer plate comprising an optical compensation film according to claim 1.

14. A liquid crystal display comprising at least one optical compensation film according to claim 1.

15. The liquid crystal display according to claim 14, wherein it includes only one optical compensation film.

16. The liquid crystal display according to claim 1, wherein it has two optical compensation films, each having a retardation value Ro from 30 to 70 nm and a retardation value Rth from 100 to 160 nm, wherein Ro stands for the retardation value in a direction of the plane and Rth stands for the retardation value in a direction of a thickness of the optical compensation film.

17. The liquid crystal display according to claim 14, wherein it is a VA display.

18. Method for the production of an optical compensation film, comprising adding at least one compound to a mixture used in the production of the compensation films during production of such films, the at least one compound comprising at least one aromatic compound with at least two aromatic rings, wherein the aromatic compound involves such a compound of Formula I: 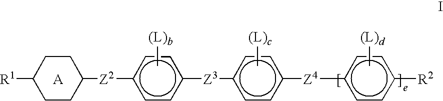
wherein
R¹ signifies straight-chain alkyl or alkoxy with 1 to 12 C atoms, wherein one or more CH₂ groups can also be replaced by —O—, —S—, —CO—, —CO—O—, —O—CO—, —O—CO—O—, —NR⁴, —CO—NR⁴—, —NR⁴—, —CO—NR⁴—, —NR⁴—CO—, so that O and/or S atoms are not linked directly with each other, wherein one or more H atoms could also be replaced by F,
R² signifies CN, F, Cl, or straight-chain alkyl or alkoxy with 1 to 12 C atoms, wherein one or more CH₂ groups can also be replaced by —O—, —S—, —CO—, —CO—O—, —O—CO—, —O—CO—O—, —NR⁴—, —CO—NR⁴—, —NR⁴—CO— so that O atoms and S atoms are not linked to each other directly, and wherein one or more H atoms can also be replaced by F,
R⁴ signifies hydrogen or C₁-C₇ alkyl,
the ring 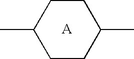
signifies either 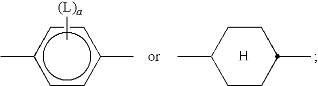
Z²-Z⁴ each signify, independent of each other, —CO—O—, —O—CO—, —CONR⁴—, —NR⁴CO—, —CH₂O—OCH₂—, CH₂S—, —SCH₂— or a simple bond,
the moieties L signify, independent of each other, H, F, or one of the moieties L also signifies Cl, and a, b, c, and d each signify, independent of each other, a whole number 0, 1, or 2, and e signifies a whole number 0 or 1.

19. The method according to claim 18, further comprising casting the film.

20. The method according to claim 18, further comprising stretching the film obtained after casting and drying, monoaxially biaxially.

21. Method for the production of a polarizer plate, comprising depositing which an optical compensation film onto a polarizer membrane or onto a protective layer of a polarizer membrane, the optical compensation film being in accordance with claim 1.

22. Method for the production of a liquid crystal display, comprising installing at least one polarizer plate on which an optical compensation film according claim 1 is deposited to.

23. The method according to claim 22, wherein only one of the optical compensation films according to claim 1 is used for the production of the liquid crystal display.

24. The method according to claim 22, wherein two of the optical compensation films according to claim 1 are used for the production of the liquid crystal display.
